(19) United States
(12) Patent Application Publication
(10) Pub. No.: US 2025/0358570 A1
(43) Pub. Date: Nov. 20, 2025

(54) CONNECTION TRANSITION FOR AUDIO PLAYBACK DEVICES

(71) Applicant: Sonos, Inc., Goleta, CA (US)

(72) Inventors: Erik Rieger, Edgewood, KY (US); Andrew Sui Tin Lee, Glasgow (GB); Shweta Mane, Louisville, KY (US); Gary Anthony Matulis, Santa Barbara, CA (US); Meng Wang, Woburn, MA (US)

(21) Appl. No.: 19/210,746

(22) Filed: May 16, 2025

Related U.S. Application Data
(60) Provisional application No. 63/648,820, filed on May 17, 2024.

(51) Int. Cl. H04R 3/12; H04R 1/10

(52) U.S. Cl. CPC H04R 3/12; H04R 1/1041; H04R 2420/07

(57) ABSTRACT

A system is configured to facilitate transitions of audio connections between playback devices. In some embodiments, the system comprises a first playback device configured to receive input via a user interface specifying a request to establish a network connection between the first playback device and a second playback device. The first playback device is also configured to receive, via a first PAN interface, a message from the second playback device, the message specifying an identifier of the second playback device. The first playback device is further configured to identify connection attributes associated with the second playback device and establish, via one of a plurality of network interfaces, a first connection with the second playback device based on the connection attributes. In some embodiments, the second playback device is configured to tear down the first connection, and establish, via a second PAN interface, a second connection with the first playback device.

### CROSS-REFERENCE TO RELATED APPLICATIONS

This application claims priority to co-pending U.S. Provisional Application No. 63/648,820 titled “CONNECTION TRANSITION FOR AUDIO PLAYBACK DEVICES” and filed on May 17, 2024, which is hereby incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D.

FIG. 3F is a schematic diagram of an example voice input.

FIGS. 4A-4D are schematic diagrams of a control device in various stages of operation in accordance with aspects of the disclosed technology.

FIG. 5 is a front view of a control device.

FIG. 6 is a message flow diagram of a media playback system.

FIG. 7 is a block diagram illustrating connection transitions enabled by some examples described herein.

FIG. 8 is a schematic diagram illustrating a playback device with multiple network interfaces.

FIG. 9 is a flow diagram illustrating a process of transitioning connections of a playback device.

FIG. 10A is a sequence diagram illustrating processes of transitioning connections of a playback device.

FIG. 10B is an sequence diagram illustrating processes of transitioning connections of a playback device.

FIG. 11 is a schematic diagram illustrating an example home theater environment.

FIG. 12 is a block diagram illustrating connection transitions enabled by some examples described herein.

FIG. 13 is a schematic diagram illustrating a playback device with multiple network interfaces.

FIGS. 14A and 14B are another sequence diagram illustrating processes of transitioning connections of a playback device.

FIGS. 15A and 15B are another sequence diagram illustrating processes of transitioning connections of a playback device.

FIG. 16 is a sequence diagram illustrating process of establishing an audio connection between playback devices.

FIG. 17 is a flow diagram illustrating a process of identifying playback devices.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

SONOS, Inc. has a long history of innovating in the wireless audio space as demonstrated by the successful launch of numerous wireless audio products including, for example, SONOS ROAM, SONOS MOVE, SONOS ERA 100, SONOS ERA 300, SONOS FIVE, SONOS RAY, SONOS BEAM, SONOS ARC, SONOS PORT, and SONOS AMP. Building upon years of experience creating sophisticated, yet easy-to-use, audio products, SONOS, Inc. has appreciated the importance of providing a high quality user experience. This high quality user experience includes ease of use and flexible options for operation. For example, consumers desire a wide array of wireless connectivity options over which to remotely control playback devices. For instance, a user may want the ability to control a playback device over a wired or wireless Local Area Network (LAN), such as via a first-party application (e.g., made by a manufacturer of the playback device) and/or a third-party application (e.g., made by a streaming media service provider), as well as via a wired or wireless Personal Area Network (PAN).

Embodiments described herein relate to swap operations, certain examples of which are described in U.S. Pat. No. 11,356,777 entitled, “Playback Transitions,” which is hereby incorporated herein by reference in its entirety. Swap operations provide users with the ability to easily switch between playback devices when listening to audio content. For instance, a user may be listening to audio being played back on a soundbar (e.g., television audio) and then desire to switch to listening to headphones to avoid disturbing other members of the household. In some examples, to accomplish this, the user may press a button on the headphones to trigger a swap of the soundbar for the headphones. This swap operation may involve establishment of an audio connection between the headphones and the soundbar such that the headphones can play back audio received from the soundbar over the newly established connection, while the soundbar ceases playing back audio. Providing the ability to transition audio connections in this manner is beneficial for users who want to switch from out-loud listening on a soundbar to private/personal listening on headphones.

At a later time, if so desired, the user can press the button again to reverse the swap operation and switch back to listening to audio played out-loud from the soundbar.

In some embodiments, a newly established audio connection between the headphones and the soundbar may be either a PAN (e.g., BLUETOOTH, ZIGBEE, etc.) or a LAN (e.g., ETHERNET, WI-FI, etc.) connection, depending on the capabilities of the soundbar. In some examples, there may be a preference for using BLUETOOTH, particularly BLUETOOTH low energy (BLE), for improved power efficiency.

As another example, a user may own a portable audio playback device that may be limited to BLUETOOTH-only operation. When using this playback device away from home, audio may be streamed to the playback device from a control device (e.g., a user device such as a smartphone or the like executing an application configured to control the playback device) over a BLUETOOTH or BLE connection. When returning home, however, the user may wish to add the portable playback device to a home theater system as a satellite playback device. In this case, the disclosed techniques may allow for the portable playback device to establish a new BLUETOOTH (or BLE) audio connection, or a new WI-FI connection, with the soundbar (or other playback device) of the home theater system.

In some embodiments, the control device facilitates the connection transition based on a previous pairing (e.g., a point-to-point pairing) between a first playback device (e.g., headphones or portable playback device) and a second playback device (e.g., a soundbar). The pairing process serves to establish credentials of the first playback device to form a trusted relationship between first and second playback devices.

To this end, embodiments described herein relate to facilitating transition between connections to different playback devices to accomplish swap operations with minimal user effort. In some embodiments, for example, the playback device is a first playback device configured to detect input, via a user interface, specifying a request to establish a network connection between the playback device and a second playback device. The first playback device may receive, via a PAN interface, a message from the second playback device specifying an identifier of the second playback device. The first playback device may identify connection attributes associated with the second playback device and establish, via one of a plurality of network interfaces, a connection with the second playback device based on the connection attributes. The first playback device may play back audio content received via the connection to the second playback device.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

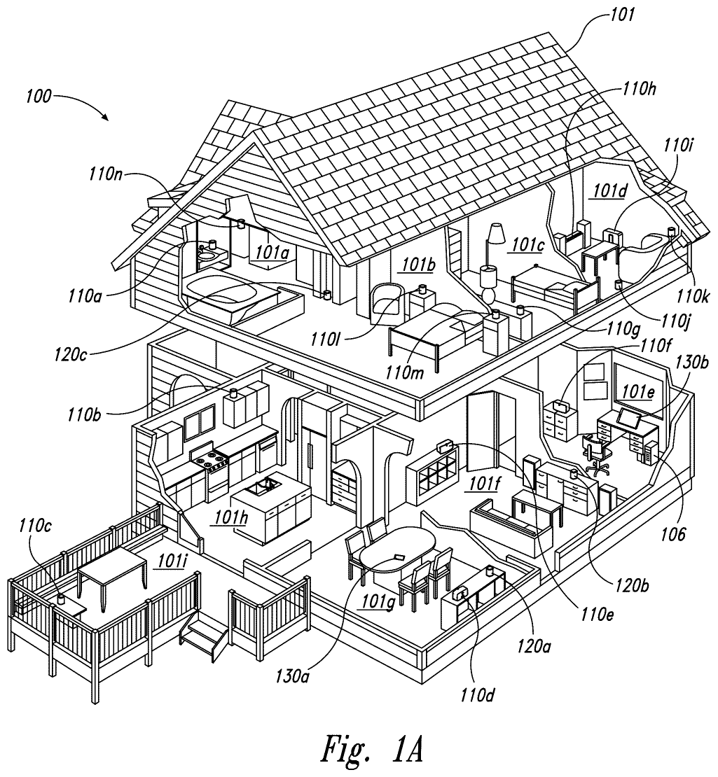

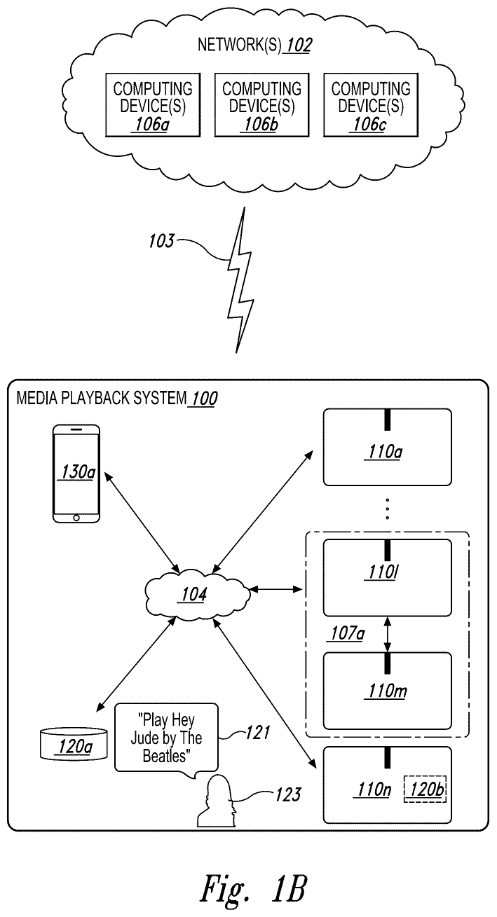

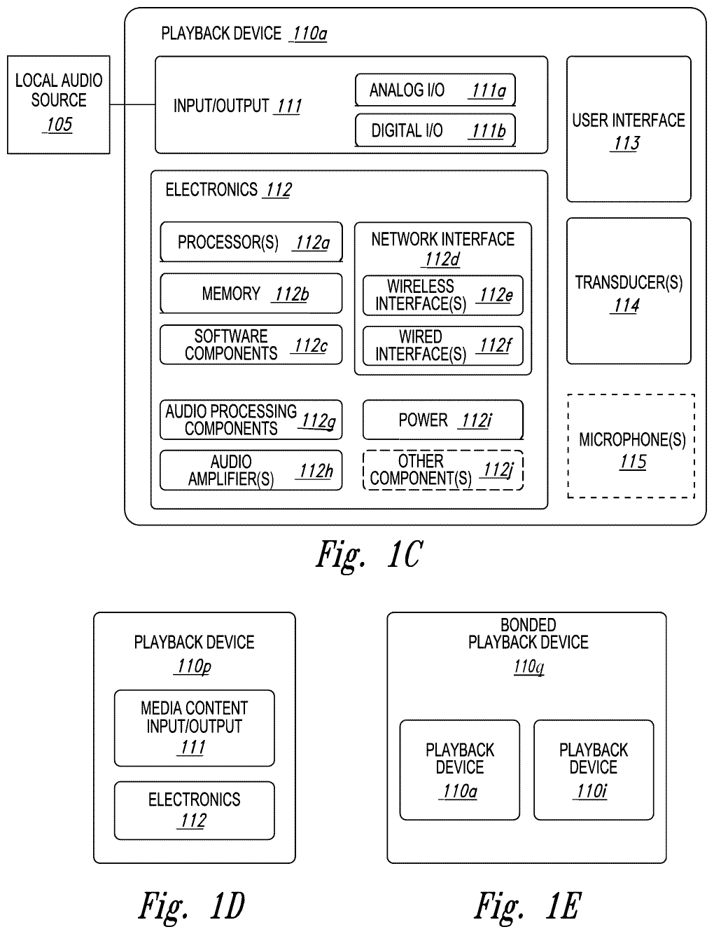

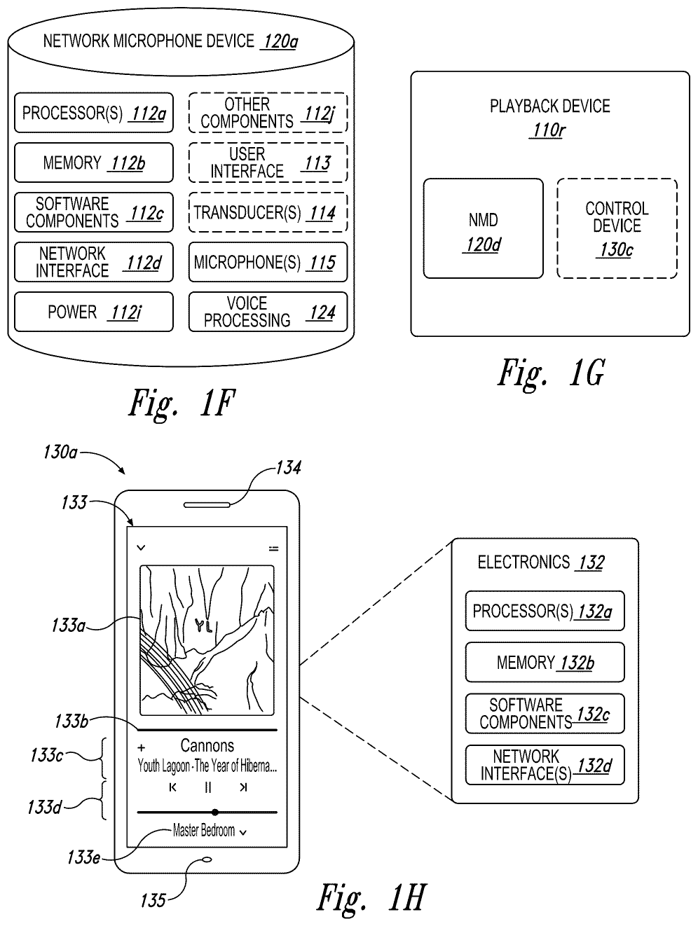

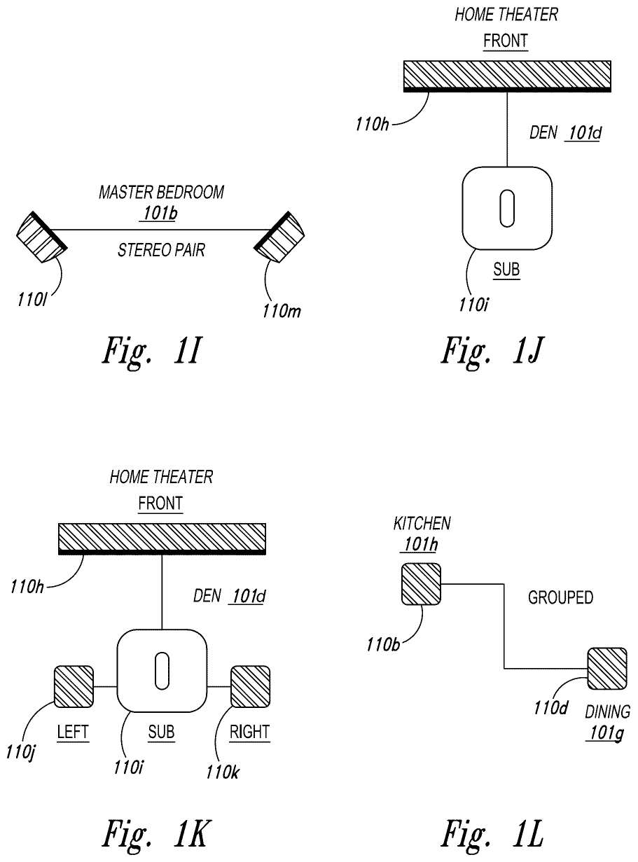

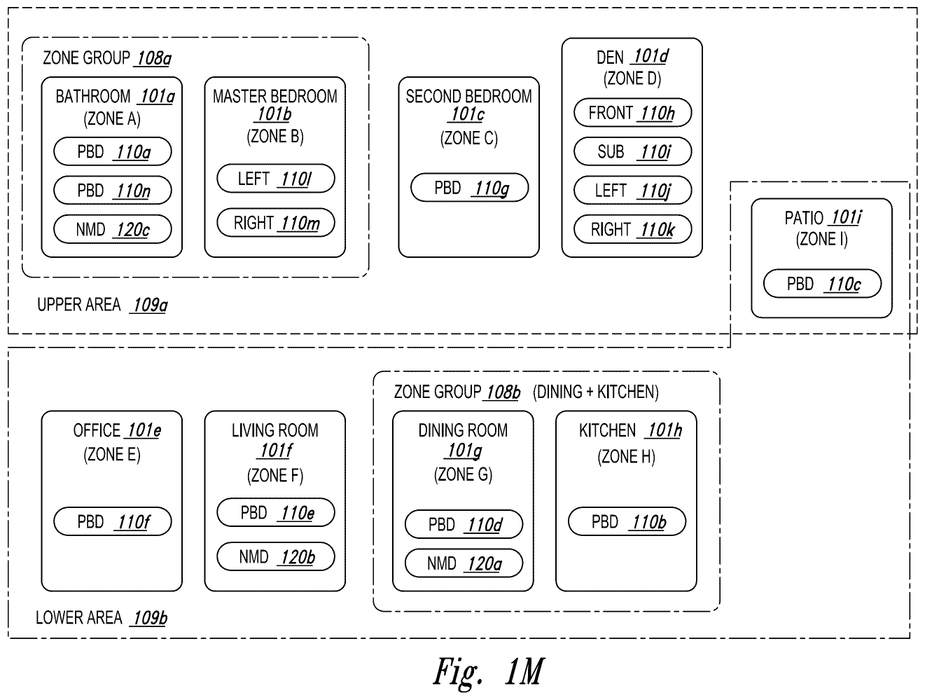

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I-1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

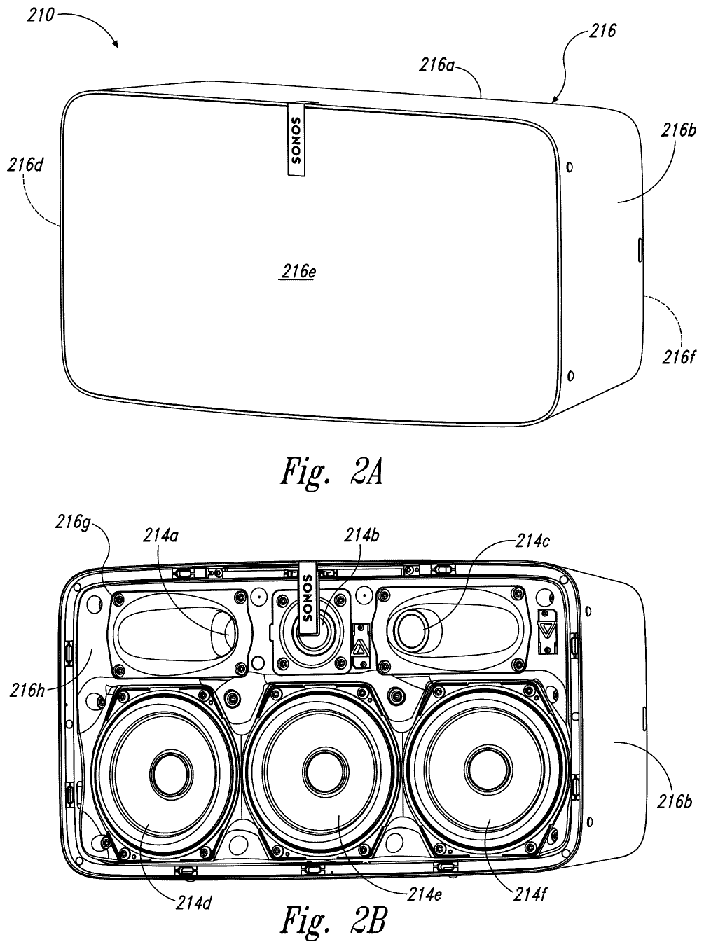

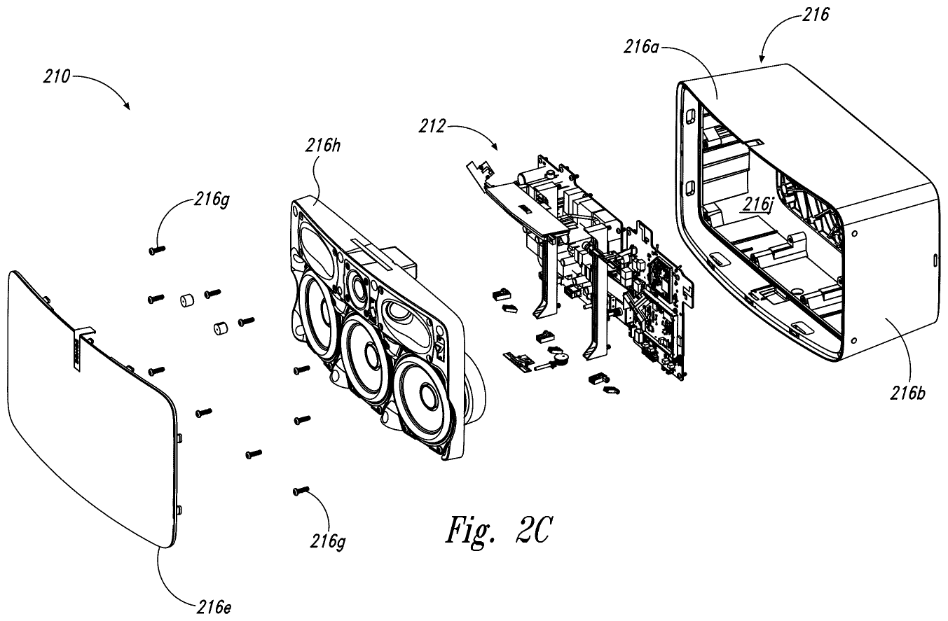

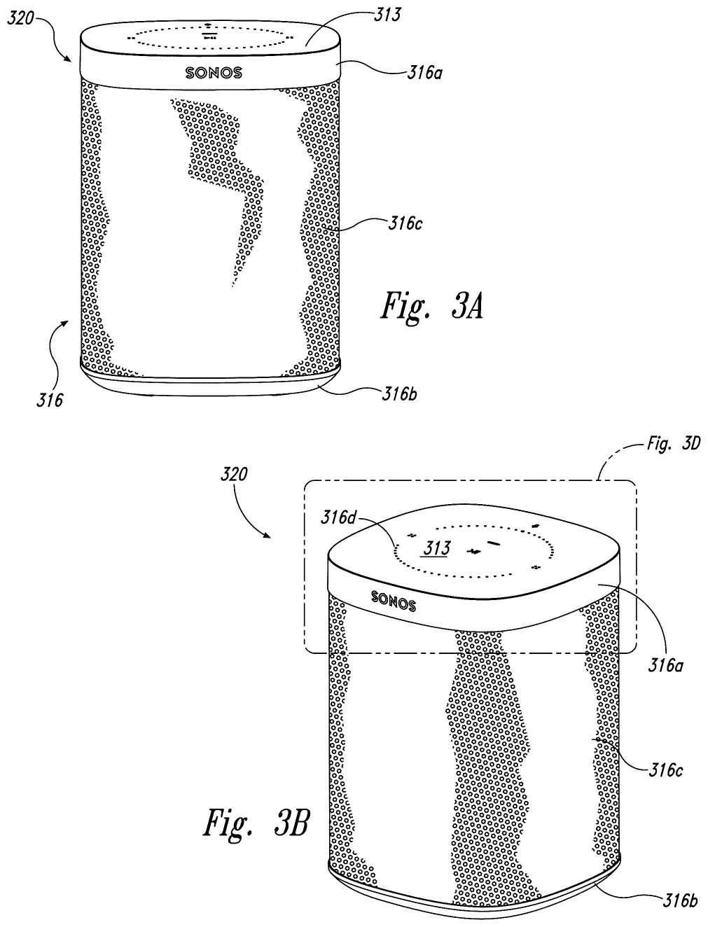

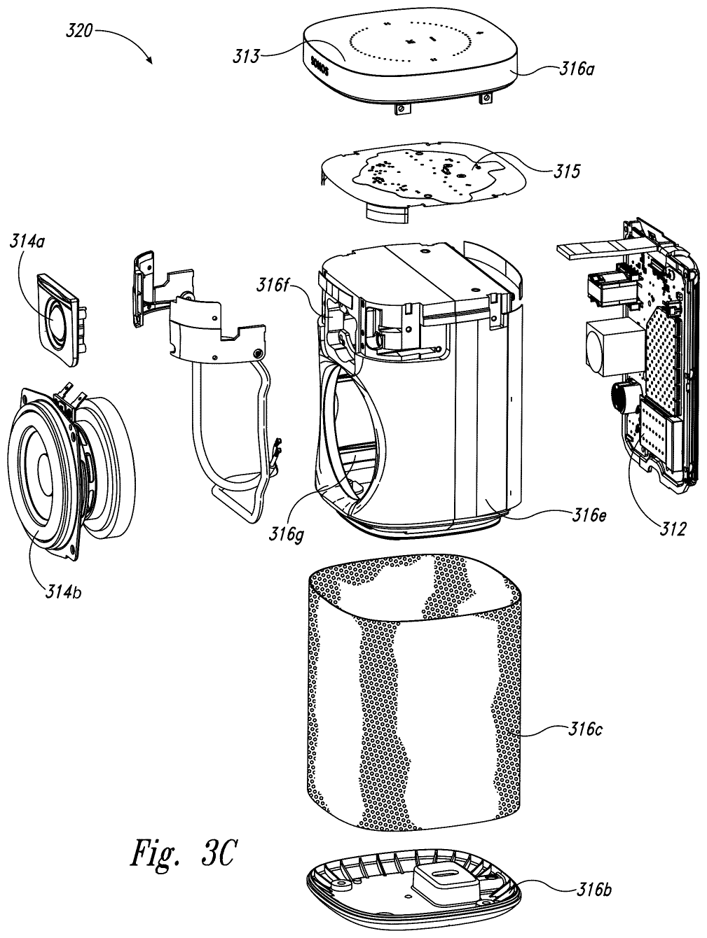

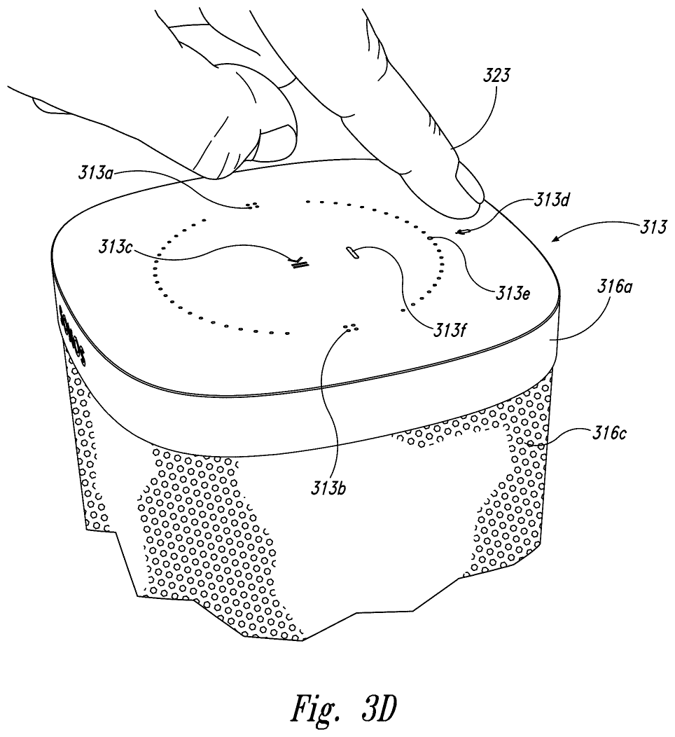

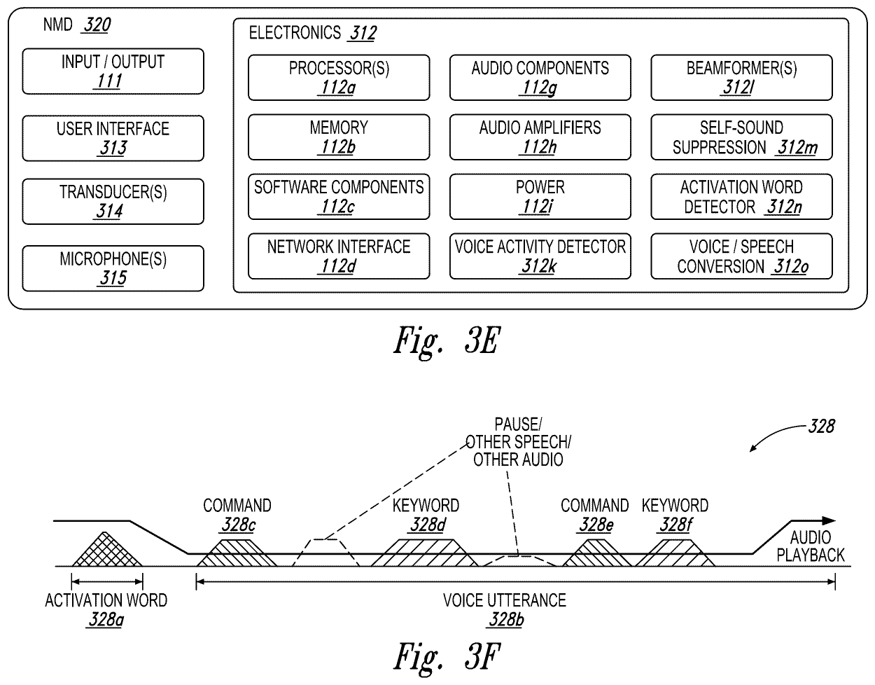

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.”

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

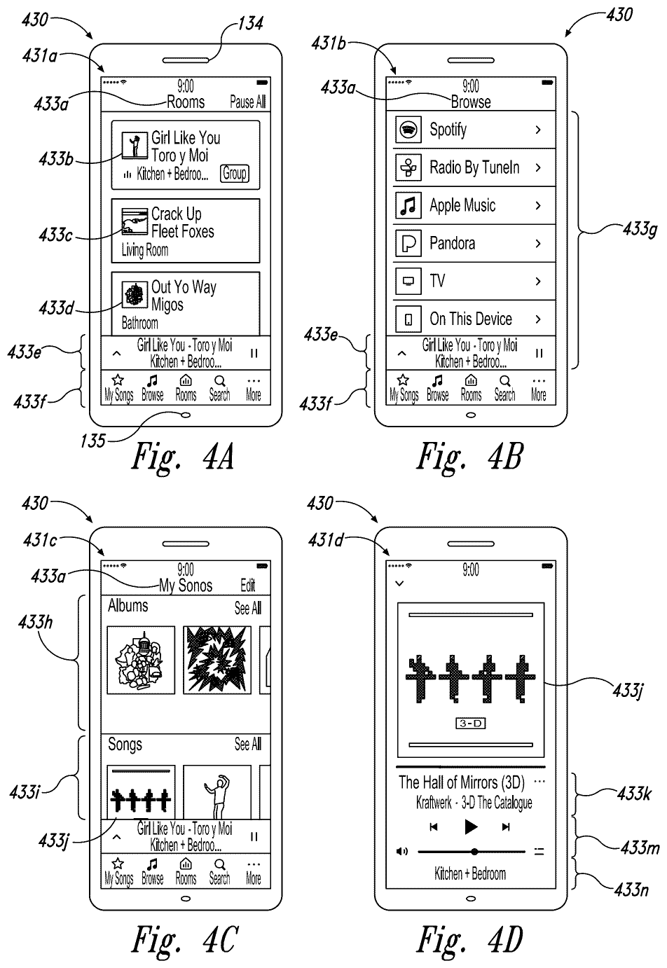

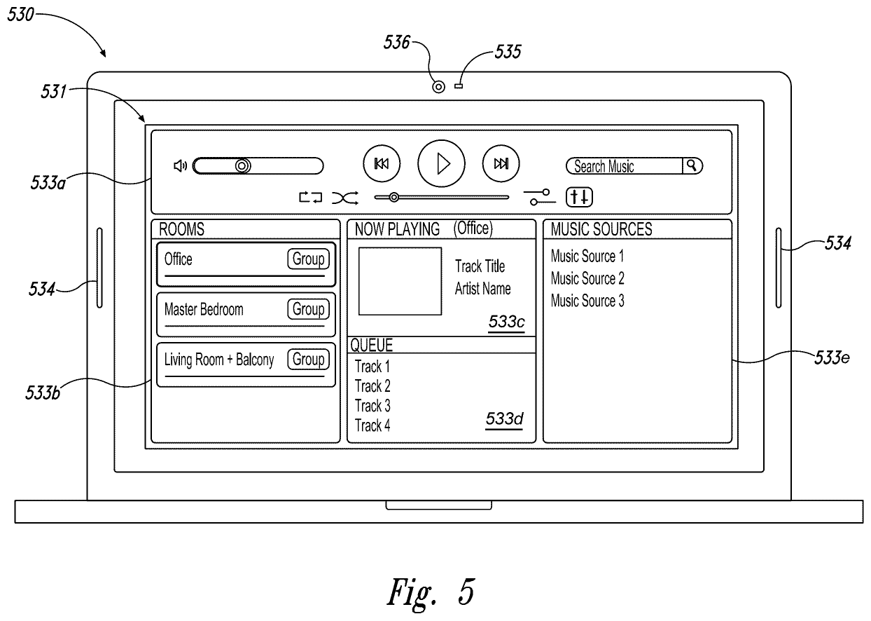

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control) that can be adjusted by a user 323. A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON's ALEXA, APPLE's SIRI, or MICROSOFT's CORTANA) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 328a can be a known activation word, such as “Alexa,” which is associated with AMAZON's ALEXA. In other embodiments, however, the voice input 328 may not include an activation word. In some embodiments, a network microphone device may output an audible and/or visible response upon detection of the activation word portion 328a. In addition, or alternately, an NMD may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 328a. The media playback system 100 may restore the volume after processing the voice input 328, as shown in FIG. 3F. Such a process can be referred to as ducking, examples of which are disclosed in U.S. Pat. No. 10,499,146, which is incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selects a graphical representation 433j (FIG. 4C), the control device 430 can be configured to begin play back of audio content corresponding to the graphical representation 433j and output a fourth user interface display 431d that includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533c, a playback zone region 533b, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

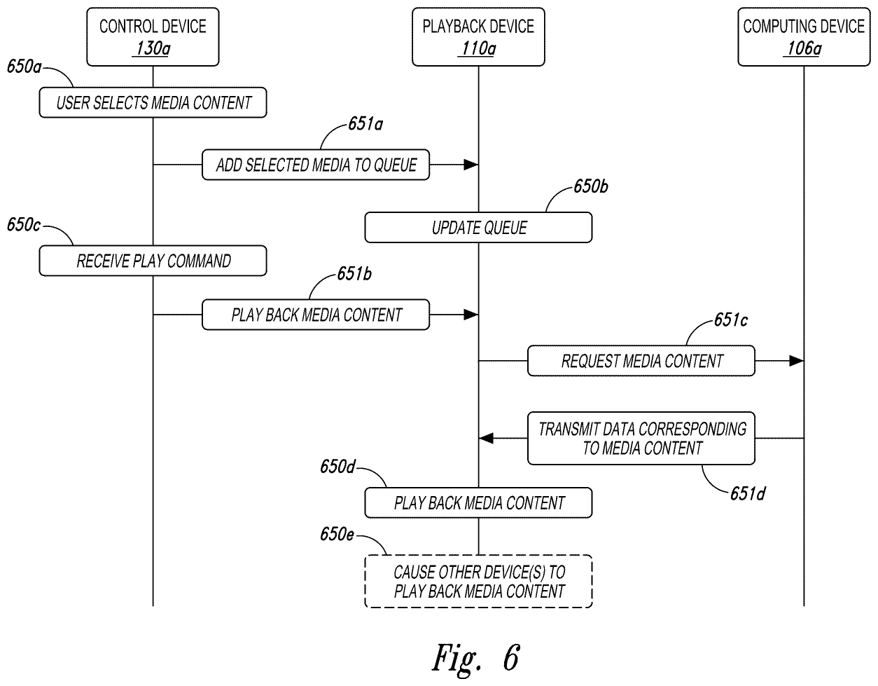

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on one or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a, and begin playback of the selected media content in response to a message from the playback device 110a such that all of the devices in the group play back the selected media content in synchrony.

### IV. Example Systems and Methods Configured for Easy Swapping of Playback Devices

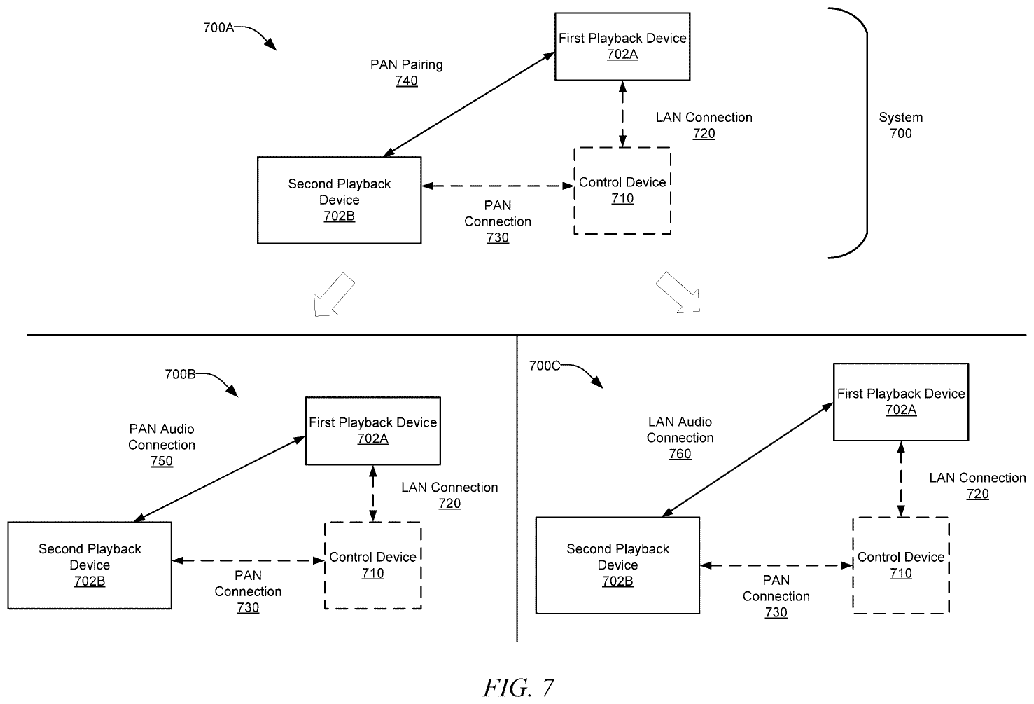

FIG. 7 illustrates a system 700 of playback devices configured to transition between distinct network connection states (700A-700C) in support of swap operations. As shown in FIG. 7, the system 700 includes two or more playback devices 702 (shown as a first playback device 702A and a second playback device 702B) and a control device 710 (rendered in dashed lines to indicate its optionality). The control device 710 may be a smartphone, tablet, or other computing device configured to interoperate with the playback devices 702, such as the control devices 130a introduced above in FIGS. 1A, 1B, 1H, or another control device. Each of the playback devices 702 may be any one of the playback devices described herein, such as the playback devices 110 introduced above in FIGS. 1C, 1D, 1G, or another playback device.

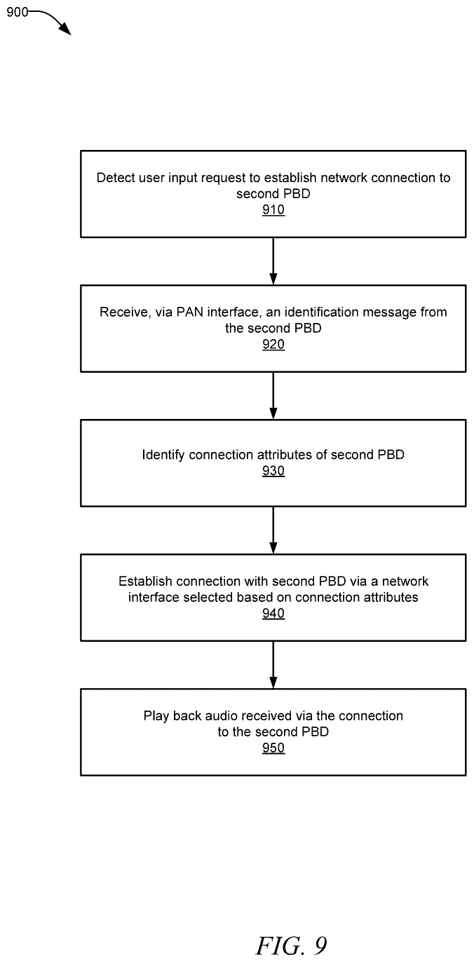

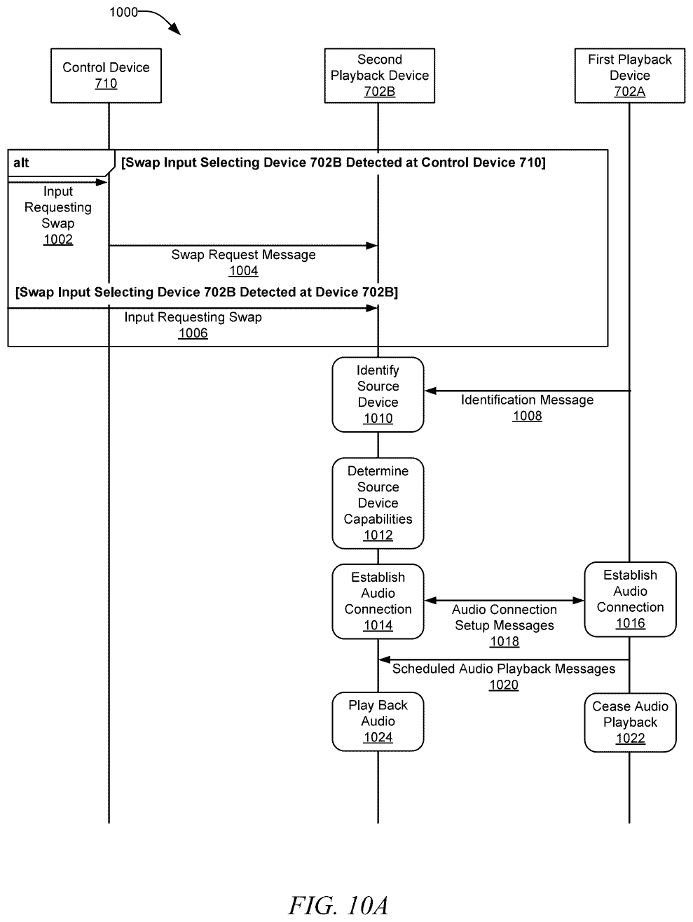

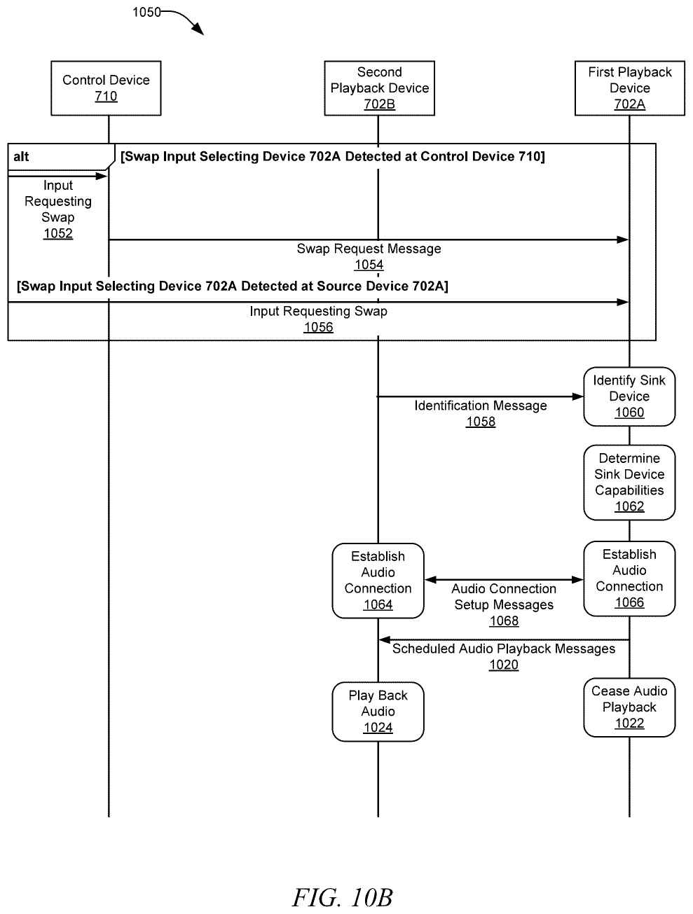

As illustrated in FIG. 7, when the system 700 is in the network state 700A, the playback devices 702 are paired 740 or are otherwise within a trusted relationship established and supported via a PAN protocol. For instance, the playback devices 702 may have previously completed a BLUETOOTH pairing process with one another. While establishing the trusted relationship, each of the playback devices 702 may exchange and store a variety of information to record the trusted relationship including device identifiers, capability indicators such as attributes of supported connections, and cryptographic data that can be used to encrypt and/or decrypt communications. Further, in the network state 700A, the control device 710 (when present) has a LAN connection 720 with the first playback device 702A and/or a PAN connection with the second playback device 702B. For instance, the control device 710 and the second playback device 702B may have previously completed a BLUETOOTH pairing process and further established a traffic bearing link. Additionally, the control device 710 may have authenticated to a LAN to which the first playback device 702A is connected and further established a user datagram protocol (UDP) or transmission control protocol (TCP) connection with the first playback device 702A. Within the network state 700A, the playback devices 702 are unable to communicate application data to one another as no data plane connection exists between the two, but one or both of the playback devices 702 can communicate with the control device 710, when the control device 710 is present. However, the playback devices 702 can beacon other devices via advertisements, as will be discussed in greater detail below. By executing a process that utilizes these advertisements or other identification messages, the playback devices 702 can transition the network state of the system 700 from the network state 700A to either the network state 700B or the network state 700C depending on the configuration and capabilities of the playback devices 702. Examples of such processes 1400 are described further below with reference to FIGS. 9-10B.

Continuing with examples illustrated by FIG. 7, when the system 700 is in the network state 700B, the playback devices 702 are connected via a PAN audio connection 750. For instance, one of the playback devices 702 may have executed the process 900 to establish a BLE audio connection with the other. Similarly, when the system 700 is in the network state 700C, the playback devices are connected via a LAN audio connection 760. For instance, the playback devices 702 may have executed one of the processes 900-1050 described below to establish a TCP or UDP connection with one another.

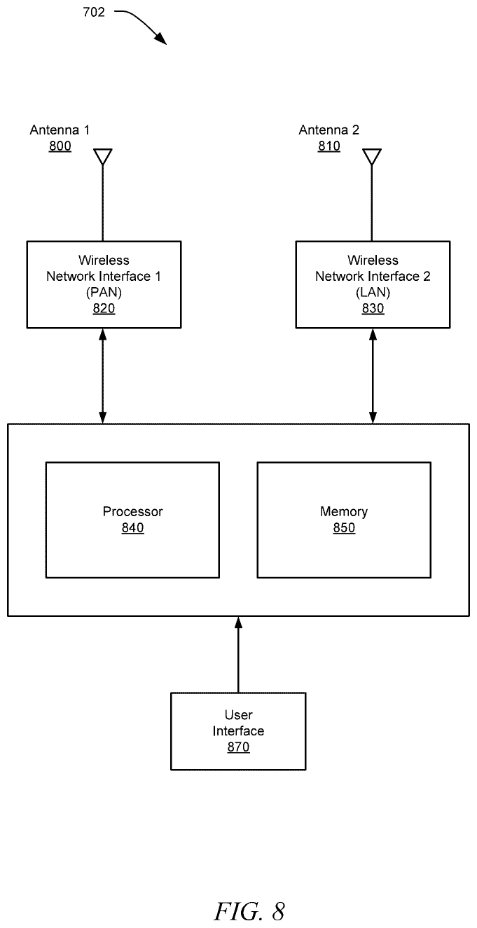

Turning now to FIG. 8, a schematic diagram of a playback device 702 (FIG. 7) is illustrated. For example, the playback device 702 may be configured to communicate over either of two network interfaces based on default settings and user selection. As illustrated in FIG. 8, the playback device 702 may include, among other things, a first network interface 820 coupled to a first antenna 800, a second network interface 830 coupled to a second antenna 810, a processor 840, memory 850, and a user interface 870. Fewer, additional, or alternative components can be included in other implementations. For instance, the network interfaces may share a common antenna and one of the first antenna 800 and the second antenna 810 may be omitted.

In some embodiments, one of the network interfaces (e.g., the first network interface 820) may be configured to communicate via a PAN and the other network interface (e.g., the second network interface 830) may be configured to communicate via a LAN. The wireless network interfaces 820 and 830 can include, among other things, a transmit buffer, transmitter circuitry, a receive buffer, and receiver circuitry. The wireless network interfaces 820 and 830 can correspond to or include the capability of the wireless interface 112e (FIG. 1) described above.

In some embodiments, the user interface 870 may include one or more buttons or other mechanisms configured to enable the user to provide input to and/or otherwise control the playback device 702, including selection of network connection and volume control.

The processor 840 includes clock-driven circuitry configured to execute instructions stored in a non-transitory computer-readable medium such as the memory 850. The processor 840 can correspond to or include the capabilities of the processor 112a (FIG. 1) described above. For example, the processor 840 can be configured to execute instructions such that the playback device is configured to execute a process for transitioning network connections, as will be described in greater detail below.

It should be appreciated that the playback device 702 is schematically illustrated in FIG. 8 as a block diagram to facilitate description of various aspects of the disclosure. Accordingly, a playback device implemented using the techniques described herein may include different components (for example, additional components, fewer components, and so forth) arranged in a different fashion than are shown in FIG. 8. For example, a playback device that implements the techniques described herein may implement one or more functions of the wireless network interfaces 820 and 830, in program instructions executed by the processor 840. Additionally, or alternatively, one or more components may be coupled between the elements shown in FIG. 8.

Turning now to FIG. 9, an example process 900 of transitioning audio connections is illustrated. The process 900 may be referred to as a swapping process. The process 900 may be executed, for example, by either of the playback devices 702 (FIG. 7). However, other system architectures and software components can be used to perform such functionality in other implementations. To this end, the correlation of the various functionalities shown in FIG. 9 to the various components of the playback devices illustrated in FIGS. 7 and 8 is not intended to imply any structural and/or use limitations. Rather, other implementations may include, for example, varying degrees of integration wherein certain functionalities are effectively performed by different configurations of circuitry. Thus, other implementations may have fewer or more parts depending on the granularity of a particular implementation.

As can be seen, the process 900 includes a number of phases and sub-processes, the sequence of which may vary from one implementation to another. In some cases, different operations may be performed in an overlapping fashion, particularly where the different overlapping operations are performed by different circuitry or code. When considered in the aggregate, these phases and sub-processes are capable of providing a transition of audio connections involving playback devices.

As shown in FIG. 9, the process 900 commences at block 910, by detecting input, via a user interface (e.g., 870 of FIG. 8) of a second playback device. The input specifies a request to establish a network connection (e.g., 750, 760 of FIG. 7) between the second playback device and a first playback device. For example, the user may wish to switch from playing audio out-loud, from a soundbar or other out-loud speaker, to playing the audio over headphones to avoid disturbing other members of the household. In some embodiments, the user interface may be a button and detecting the input may comprise receiving an indication of actuation of the button.

At block 920, the process 900 further includes receiving, via a PAN interface (e.g., 820 of FIG. 8) of the second playback device, an identification message from the first playback device. In some examples, the message specifies an identifier of the first playback device. In some embodiments, the message received from the first playback device is a PAN advertisement or some other beacon message.

At block 930, the process 900 further includes identifying connection attributes associated with the first playback device. In some examples, the connection attributes specify a connection type supported by the first playback device. The connection type may be one of a PAN connection type or a LAN connection type. In some instances, the second playback device maintains in memory (e.g., 850 of FIG. 8) a table or list of other playback devices, for example devices for which there has been a previous pairing, and then uses the identifier received in the message from the first playback device to access that table and extract connection attributes associated with the first playback device which are stored in the table. In some examples, the second playback device parses the identification message to extract one or more connection attributes (e.g., WI-FI channel for a LAN connection) from the identification message.

At block 940, the process 900 further includes establishing, via one of a plurality of network interfaces of the second playback device, a connection with the first playback device based on the connection attributes. In some examples, establishing the connection includes extracting the supported connection type from the connection attributes. The connection type may be one of a PAN connection type or a LAN connection type. The plurality of network interfaces may include a PAN interface (e.g., 820 of FIG. 8) and a LAN interface (e.g., 830 of FIG. 8). For example, the LAN interface may be configured to facilitate communication using at least one WI-FI communication protocol. In another example, the PAN interface may be configured to facilitate communication using at least one BLUETOOTH communication protocol. In certain examples, the PAN interface includes a BLE interface configured to provide operation with increased power efficiency.

At block 950, the process 900 further includes playing back, by the second playback device, audio content received via the connection to the first playback device, where the connection is the PAN connection or the LAN connection depending on the capabilities of the first playback device as specified by the connection attributes.

In some instances, for example in environments that comprise additional playback devices, it may be desirable to establish the connection with the closest other playback device. This may be accomplished by determining that the distance between the second playback device and the first playback device is less than the distance between the second playback device and a third playback device. In some embodiments, the distances may be estimated by analyzing a power or signal-to-noise ratio of a signal conveying the identification message. For example, the distances may be estimated based on a comparison of the power of a signal conveying the identification message to a transmission power stored in the identification message.

In some instances, the system may operate more efficiently if the first playback device initiates the PAN audio connection which allows the first playback device to better manage scheduling of audio packet transmissions. Therefore, in some embodiments, the process further includes denying an initial connection request from the second playback device, or terminating (tearing down) an initial connection between the playback devices and establishing a new connection initiated by the first playback device. The new connection may then be used to receive audio content from the first playback device for playing back by the second playback device. If the process includes denying the initial connection request, the process may further include verifying, by the first playback device, that the second playback device is a trusted device. This verification may be accomplished by matching an identifier of the second playback device included in the denied connection request message to an identifier within a list of identifiers of trusted devices maintained by the first playback device.

In some examples, the first playback device is configured to start a PAN broadcast session after denial of the initial connection request, or tear down of the initial connection, and prior to establishment of the new connection. Since broadcasts are not guaranteed to be reliable, the first playback device may broadcast multiple copies of audio packets over the new connection to increase reliability. In some embodiments, the multiple copies may include an original transmission and two retransmissions. The second playback device may then play back audio content based on one of the copies of the audio data.

In some embodiments, the process further includes, after establishing the connection with the first playback device, exchanging volume control information between the second playback device and the first playback device to maintain relative continuity in volume levels after the transition. For example, after switching between the out-loud and headphones, or vice-versa, it may be desirable for the user to perceive a consistent volume level.

FIG. 10A illustrates another swapping process 1000 that the devices introduced in FIG. 7 are configured to execute, in some examples. As shown in FIG. 10A, the process 1000 starts with either the control device 710 receiving input 1002 requesting a swap operation between the playback devices 702, or the second playback device 702B receiving input 1006 requesting the swap operation. For example, the input 1006 may include an actuation of a button of the second playback device 702B that is designated to initiate the swap operation. The button may be part of a user interface of the second playback device 702B, such as the user interface 113 (FIG. 1C). The input 1006 may be or include some other gesture and/or a voice command to initiate the swap operation. The ability of a playback device to detect and process voice commands is described above with reference to FIGS. 3A-3D. Alternatively or additionally, in some examples, the control device 710 receives input 1002 requesting the swap operation. For instance, where the control device 710 includes a touchscreen, the input 1002 may be a selection of a control, such as a virtual button, rendered via the touchscreen by a control application executed by the control device 710. The input 1002 may also include a voice command detected by the control device 710. Other examples of the input 1002, 1006 that may be detected by the second playback device 702B and/or the control device 710 will be apparent in view of this disclosure.

Continuing with the process 1000, if the control device 710 detects the input 1002, the control device 710 generates and communicates a message 1004. The message 1004 may specify a request to initiate a swap operation. For instance, the message 1004 may be an application programming interface (API) call transmitted by the control device 710 to the second playback device 702B via a PAN connection (e.g., 730 of FIG. 7). Alternatively, if the second playback device 702B and the control device 710 are both connected to a LAN, the message may be an API call communicated via a LAN connection.

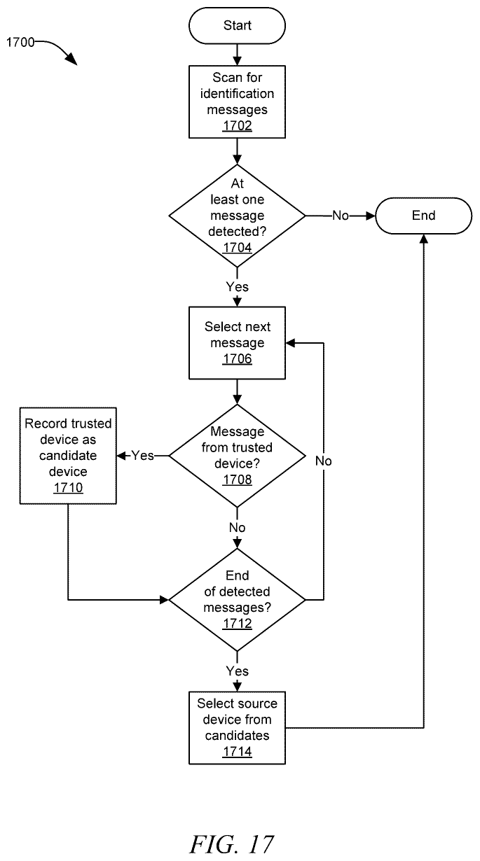

Continuing with the process 1000, in response to receiving the input 1006 and/or the message 1004, the second playback device 702B initiates the requested swap operation by identifying 1010 a source playback device from which the second playback device 702B is to receive audio data after the swap operation is complete. FIG. 17 illustrates one example of a device identification process 1700 executed by the second playback device in some examples. As shown in FIG. 17, the process 1700 starts with the second playback device scanning 1702 for identification messages. For instance, in some examples of the operation 1010, the second playback device 702B scans, via one or more integrated network interfaces (e.g., 820, 830 of FIG. 8), for identification messages transmitted by other playback devices proximal to the second playback device 702B. Such identification messages may include, for example, PAN or LAN advertisement messages (e.g., BLUETOOTH Advertisements, SSID broadcasts, etc.). The duration of the scan may vary between examples. For instance, in some examples, the second playback device 702B continues to scan until a timeout (e.g., up to 5 seconds) occurs or until at least one identification message that originated from a trusted playback device is detected, as discussed below. In other examples, the second playback device 702B scans for a fixed time period (e.g. 1 second, 2 seconds, 3 seconds, or another duration up to 5 seconds) to collect potentially multiple identification messages for subsequent processing.

Continuing with the process 1700, the second playback device determines 1704 whether at least one identification message was detected via execution of the scanning operation 1702. If the second playback device determines that no identification message was detected, the second playback device may terminate this instance of the process 1700. If the second playback device determines at at least one identification message was detected, the second playback device proceeds to operation 1706.

Continuing with the process 1700, the second playback device selects 1706 the next identification message not yet processed by this instance of the process 1700 and determines 1708 whether the selected message originated from a trusted device. For instance, in some examples, the second playback device 702B parses each detected identification message to extract an identifier of a device that originated the message. Further, in these examples, the second playback device 702B searches a locally stored list of identifiers of trusted playback devices for an identifier that matches (e.g., is the same as) the extracted identifier. This list of identifiers may be stored in a table or other data structure within onboard memory (e.g., 850 of FIG. 8). If a match is found, the second playback device 702B records 1710 the trusted playback device identified by the extracted identifier as a candidate source playback device and proceeds to the operation 1712. If no match is found, the second playback device 702B disregards the identification message and proceeds to the operation 1712.

Continuing with the process 1700, the second playback device determiners 1712 whether any identification message detected via the scanning operation 1702 remains unprocessed by this instance of the process 1700. If unprocessed messages remain, the second playback device returns to the operation 1706 and selects 1706 the next, unprocessed message for processing. If no unprocessed messages remain, the second playback device proceeds to operation 1714.

Continuing with the process 1700, the second playback device selects 1714 a source device from the candidate devices. In certain examples, the second playback device 702B selects the first candidate playback device to be identified as a source playback device for the swap operation. Alternatively or additionally, if multiple candidates are identified, the second playback device 702B determines a proximity of each candidate to the second playback device 702B and selects the closest candidate as the source playback device. In some examples, the second playback device 702B determines proximity of each candidate by analyzing a strength of a signal that conveyed the identification message from the candidate. This analysis of signal strength may include calculation of a signal to noise ratio. Alternatively or additionally, in some examples, each identification message may specify a transmit power of the signal conveying the message and the second playback device 702B may calculate an amount of signal attenuation as an indicator of proximity. These and other signal strength metrics that can be used to determine relative distance between playback devices will be apparent in view of this disclosure. Additionally or alternatively, within the operation 1010, the second playback device 702B may use acoustic signaling techniques to determine relative proximity of candidates. Examples of playback devices equipped with ultrasonic presence detection are disclosed in U.S. Patent Publication Nos. 2022/0066008 and 2022/0261212, each of which is hereby incorporated herein by reference in its entirety for all purposes. In these examples, the second playback device 702B transmits an unsolicited acoustic signal and calculates a turnaround time between transmission and reception of a responsive acoustic signal from each candidate device. The turnround time for each candidate device provides an estimate of relative distance between the second playback device 702B and the candidate device.

Subsequent to the operation 1714, the process 1700 may end.

It should be noted that the process 1700 described above may also be executed by the first playback device to identify a sink device, as is illustrated as operation 1060 in FIG. 10B and described further below. In this situation, the description of the process 1700 applies, but with the first playback device and the second playback device being substituted for one another.

As shown in FIG. 10A, the second playback device 702B receives an identification message 1008 from the first playback device 702A. The second playback device 702B processes the identification message 1008 and selects the first playback device 702A as a source playback device for the swap operation.

Continuing with the process 1000, the second playback device 702B determines 1012 capabilities of the source playback device selected in operation 1010. These determined capabilities may include, for example, connection attributes, such as the types of networks (e.g., LANs, PANs, etc.) and network connections (TCP, UDP, BLUETOOTH, BLE audio, etc.) that the source playback device supports. For instance, some source playback devices of a first type may support PAN identification messages, but not PAN audio connections, while source playback devices of a second type may support both PAN identification messages and PAN audio connections. The second playback device 702B may interoperate with source playback devices of the first type to establish an audio connection that is not a PAN connection (e.g., a LAN connection). The second playback device 702B may interoperate with source playback devices of the second type to establish an audio connection that is a PAN connection.

In some examples, the second playback device 702B determines connection attributes supported by a source playback device by extracting supported connection attributes associated with the source playback device from a local data store (e.g., a table stored in the memory 850 of FIG. 8) keyed on an identifier of the source playback device (e.g., serial number, model number etc.). Alternatively or additionally, the second playback device 702B may extract supported connection attributes from identification messages or connection setup messages specifying the same. Connection setup messages are described further below with reference to operations 1014 and 1016.

Continuing with the process 1000, the second playback device 702B and the source playback device interoperate to establish 1014, 1016 a preferred audio connection. As shown in FIG. 10A, this interoperation involves exchanging a plurality of setup messages 1018. The information specified within the setup messages 1018 depends on a variety of factors. These factors may include the type of network and network connection preferred for audio and the capabilities of the second playback device 702B and the source playback device. In at least one example, a BLE audio connection is preferred to conserve energy consumed by the source playback device and the second playback device 702B after the swap operation is complete. The setup messages 1018 may further specify operational parameters (e.g., parameters specifying volume level and equalizer settings, among others) that effect playback of audio content by the second playback device 702B. In addition, the setup messages 1018 may specify a request from the second playback device 702B for the source playback device to participate in the swap operation. Other content that may be specified in the setup messages 1018 will be apparent in view of this disclosure.

In one example illustrated in FIG. 10A, the second playback device 702B and the first playback device 702A establish a LAN audio connection (e.g., 760 of FIG. 7).

Continuing with the process 1000, after the audio connection is established, the source playback device generates and transmits messages 1020 specifying audio data scheduled for playback by the second playback device 702B. The second playback device 702B receives and processes the playback messages 1020 to play back 1024 the audio content according to the schedule specified therein. In some examples illustrated by FIG. 10A, the source playback device ceases 1022 audio playback after initial transmission of at least one of the messages 1020. In certain examples, the source playback device ceases 1022 audio playback in synchrony with the start of playback by the second playback device 702B. Additional details regarding the scheduling and playing back audio content are described in U.S. Pat. No. 8,234,395, cited above.

It should be noted that the swap operation resulting from execution of the process 1000 can be reversed as follows, in some examples. The second playback device 702B may receive input or a message from the control device 710 requesting the reversal and, in response thereto, may communicate a reversal request to the first playback device 702A. The first playback device 702A may receive and process the reversal request. This processing may include ceasing generation and transmission of the messages 1020, tearing down of the audio connection established by the operations 1014 and 1016, and resuming playback of the audio content. In some examples, the first playback device 702A may synchronize resumption of playback of the audio content with cessation of playback of the audio content by the second playback device 702B.

FIG. 10B illustrates another swapping process 1050 that the devices introduced in FIG. 7 are configured to execute, in some examples. As shown in FIG. 10B, the process 1050 starts with either the control device 710 receiving input 1052 requesting a swap operation between the playback devices 702 or the first playback device 702A receiving input 1056 requesting the swap operation. For example, the input 1056 may include an actuation of a button of the first playback device 702A that is designated to initiate the swap operation. The button may be part of a user interface of the first playback device 702A, such as the user interface 113 (FIG. 1C). The input 1056 may be or include some other gesture and/or a voice command to initiate the swap operation. The ability of a playback device to detect and process voice commands is described above with reference to FIGS. 3A-3D. Alternatively or additionally, in some examples, the control device 710 receives input 1052 requesting the swap operation. For instance, where the control device 710 includes a touchscreen, the input 1052 may be a selection of a control, such as a virtual button, rendered via the touchscreen by a control application executed by the control device 710. The input 1052 may also include a voice command detected by the control device 710. Other examples of the input 1052, 1056 that may be detected by the first playback device 702A and/or the control device 710 will be apparent in view of this disclosure.

Continuing with the process 1050, if the control device 710 detects the input 1052, the control device 710 generates and communicates a message 1054. The message 1054 may specify a request to initiate a swap operation. For instance, the message 1054 may be an API call transmitted by the control device 710 to the first playback device 702A via a LAN connection (e.g., 720 of FIG. 7). Alternatively, if the first playback device 702A and the control device 710 are both connected to a PAN, the message may be an API call communicated via a PAN connection.

Continuing with the process 1050, in response to receiving the input 1056 and/or the message 1054, the first playback device 702A initiates the requested swap operation by identifying 1060 a sink playback device to which the first playback device 702A is to transmit audio data after the swap operation is complete. For instance, in some examples of the operation 1060, the first playback device 702A scans, via one or more integrated network interfaces (e.g., 820, 830 of FIG. 8), for identification messages transmitted by other playback devices proximal to the first playback device 702A. Such identification messages may include, for example, PAN or LAN advertisement messages (e.g., BLUETOOTH Advertisements, SSID broadcasts, etc.). The duration of the scan may vary between examples. For instance, in some examples, the first playback device 702A continues to scan until a timeout (e.g., up to 5 seconds) occurs or until at least one identification message that originated from a trusted playback device is detected, as discussed below. In other examples, the first playback device 702A scans for a fixed time period (e.g. 1 second, 2 seconds, 3 seconds, or another duration up to 5 seconds) to collect potentially multiple identification messages for subsequent processing.

Further, in some examples of the operation 1060, the first playback device 702A determines whether any detected identification messages originated from a trusted playback device. For instance, in these examples, the first playback device 702A parses each detected identification message to extract an identifier of a device that originated the message. Further, in these examples, the first playback device 702A searches a locally stored list of identifiers of trusted playback devices for an identifier that matches the extracted identifier. This list of identifiers may be stored in a table or other data structure within onboard memory (e.g., 850 of FIG. 8). If a match is found, the first playback device 702A records the trusted playback device identified by the extracted identifier as a candidate sink playback device. If no match is found, the second playback device 702B disregards the identification message.

In certain examples of the operation 1060, the first playback device 702A selects the first candidate playback device to be identified as a sink playback device for the swap operation. Alternatively or additionally, if multiple candidates are identified, the first playback device 702A determines a proximity of each candidate to the first playback device 702A and selects the closest candidate as the sink playback device. In some examples, the first playback device 702A determines proximity of each candidate by analyzing a strength of a signal that conveyed the identification message from the candidate. This analysis of signal strength may include calculation of a signal to noise ratio. Alternatively or additionally, in some examples, each identification message may specify a transmit power of the signal conveying the message and the first playback device 702A may calculate an amount of signal attenuation as an indicator of proximity. These and other signal strength metrics that can be used to determine relative distance between playback devices will be apparent in view of this disclosure. Additionally or alternatively, within the operation 1060, the first playback device 702A may use acoustic signaling techniques to determine relative proximity of candidates. Examples of playback devices equipped with ultrasonic presence detection are disclosed in U.S. Patent Publication Nos. 2022/0066008 and 2022/0261212, each of which is hereby incorporated herein by reference in its entirety for all purposes. In these examples, the first playback device 702A transmits an unsolicited acoustic signal and calculates a turnaround time between transmission and reception of a responsive acoustic signal from each candidate device. The turnround time for each candidate device provides an estimate of relative distance between the first playback device 702A and the candidate device.

As shown in FIG. 10B, the first playback device 702A receives an identification message 1058 from the first playback device 702A. The first playback device 702A processes the identification message 1058 and selects the second playback device 702B as a sink playback device for the swap operation.

Continuing with the process 1050, the first playback device 702A determines 1062 capabilities of the sink playback device selected in operation 1010. These determined capabilities may include, for example, connection attributes, such as the types of networks (e.g., LANs, PANs, etc.) and network connections (TCP, UDP, BLUETOOTH, BLE audio, etc.) that the sink playback device supports. For instance, some sink playback devices of a first type may support PAN identification messages, but not PAN audio connections, while sink playback devices of a second type may support both PAN identification messages and PAN audio connections. The first playback device 702A may interoperate with sink playback devices of the first type to establish an audio connection that is not a PAN connection (e.g., a LAN connection). The first playback device 702A may interoperate with sink playback devices of the second type to establish an audio connection that is a PAN connection.

In some examples, the first playback device 702A determines connection attributes supported by a sink playback device by extracting supported connection attributes associated with the sink playback device from a local data store (e.g., a table stored in the memory 850 of FIG. 8) keyed on an identifier of the sink playback device (e.g., serial number, model number etc.). Alternatively or additionally, the first playback device 702A may extract supported connection attributes from identification messages or connection setup messages specifying the same. Connection setup messages are described further below with reference to operations 1064 and 1066.

Continuing with the process 1050, the first playback device 702A and the sink playback device interoperate to establish 1064, 1066 a preferred audio connection. As shown in FIG. 10B, this interoperation involves exchanging a plurality of setup messages 1068. The information specified within the setup messages 1068 depends on a variety of factors. These factors may include the type of network and network connection preferred for audio and the capabilities of the first playback device 702A and the sink playback device. In at least one example, a BLE audio connection is preferred to conserve energy consumed by the sink playback device and the first playback device 702A after the swap operation is complete. The setup messages 1068 may further specify operational parameters (e.g., parameters specifying volume level and equalizer settings, among others) that effect playback of audio content by the sink playback device. In addition, the setup messages 1068 may specify a request from the first playback device 702A for the sink playback device to participate in the swap operation. Other content that may be specified in the setup messages 1068 will be apparent in view of this disclosure.

In one example illustrated in FIG. 10B, the first playback device 702A and the second playback device 702B establish a PAN audio connection (e.g., 750 of FIG. 7).

Continuing with the process 1050, after the audio connection is established, the first playback device 702A generates and transmits messages 1020 specifying audio data scheduled for playback by the sink playback device. The sink playback device receives and processes the playback messages 1020 to play back 1024 the audio content according to the schedule specified therein. In some examples illustrated by FIG. 10B, the first playback device 702A ceases 1022 audio playback after initial transmission of at least one of the messages 1020. In certain examples, the first playback device 702A ceases 1022 audio playback in synchrony with the start of playback by the sink playback device. Additional details regarding the scheduling and playing back audio content are described in U.S. Pat. No. 8,234,395, cited above.

In some embodiments, the first playback device 702A simply relays audio data received from a third device to the second playback device 702B without further processing of the audio data. In other embodiments, the first playback device 702A is a primary playback device, such as a soundbar, smartphone, streaming box, streaming stick, control device, or the like, that at least partially decodes audio data prior to communicating the decoded audio data to the second playback device. One example in which the first playback device 702A is a soundbar of a home theater system and the second playback device 702B is a wearable device (e.g., a headphone) or other portable device (e.g., a BLUETOOTH enable portable out-loud speaker) will now be described.

It should be noted that the swap operation resulting from execution of the process 1050 can be reversed as follows, in some examples. The first playback device 702A may receive input or a message from the control device 710 requesting the reversal and, in response thereto, may communicate a reversal request to the second playback device 702B. The first playback device 702A may further cease generation and transmission of the messages 1020, tear down of the audio connection established by the operations 1064 and 1066, and resume playback of the audio content. In some examples, the first playback device 702A may synchronize resumption of playback of the audio content with cessation of playback of the audio content by the second playback device 702B.

### V. Example Home Theater Environments and Swapping Operations

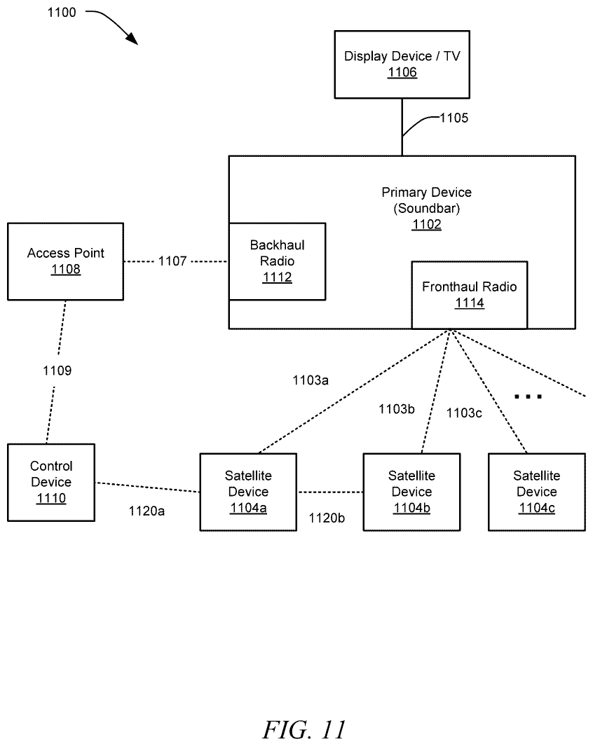

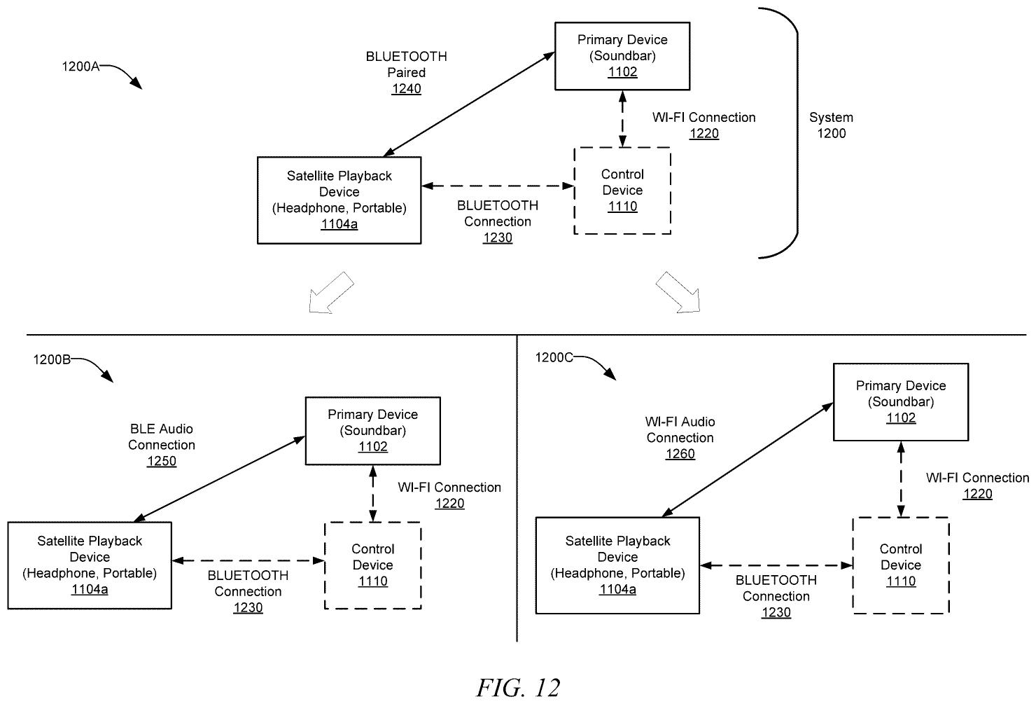

FIG. 11 illustrates an example of a home theater environment 1100. As shown, home theater environment 1100 comprises a display device 1106, such as a television or monitor, that displays visual content and outputs audio content that is associated with the displayed visual content via a communication link 1105 to a primary playback device 1102 (for example, a soundbar, a smart television box, a smart television stick, and so forth). The primary playback device 1102 is capable of receiving audio via an audio input interface from a television, media player (for example, set-top box, streaming media playback device, computer), or other home theater source. Further, the primary playback device 1102 may operate as a sourcing device for a bonded zone (for example, a home theater group) that includes one or more satellite playback devices 1104, also referred to herein as “satellites.” The satellites may play back certain channels (for example, as the playback devices 110j and 110k can) and/or certain frequency ranges (for example, as the playback device 110i can), as shown, for example, in FIGS. 1K and 1J illustrating the den 101d.

The primary playback device 1102 includes a first radio 1112 (also referred to as a “backhaul radio”) and, using the first radio 1112, communicates with an access point (AP) 1108 via a communication link 1107 (for example, a backhaul connection). Additionally, the primary playback device 1102 includes a second radio 1114 (also referred to as a “fronthaul radio”) and, using the second radio 1114, communicates with one or more satellite playback devices 1104a, 1104b, 1104c, etc. via one or more communication links 1103a, 1103b, 1103c, etc., The access point 1108, in turn, communicates with other devices such as a user device 1110 (for example, a smartphone, tablet, laptop, desktop computer, and so forth) via a communication link 1109. In some examples, the primary playback device 1102 may be integrated with the display device 1106. For example, a television may include a smart soundbar.

In some instances, the home theater environment 1100 may play back audio from a music streaming service. In such instances, the primary playback device 1102 may communicate with one or more cloud servers associated with a music service provider (for example, via the communication link 1107 to the access point 1108) to obtain the audio content for playback. After receipt of the audio content for playback, the primary playback device 1102 may communicate the audio content (or any portion thereof) to the satellite playback devices 1104a, 1104b, 1104c, for synchronous playback via the communication links 1103a, 1103b, 1103c. In examples where the primary playback device 1102 is implemented as a soundbar (or otherwise comprises transducers for rendering audio content), the primary playback device 1102 may render the audio content in synchrony with the satellite playback devices 1104a, 1104b, 1104c. In such examples, the primary playback device 1102 and the satellite playback devices 1104a, 1104b, 1104c form a home theater bonded zone or group, as discussed above with reference to FIG. 1J, for example. In examples where the primary playback device 1102 is implemented as a smart television box or smart television stick (or otherwise does not comprise transducers for rendering audio content), the satellite playback devices 1104a, 1104b, 1104c may render the audio content in synchrony with each other while the primary playback device 1102 may not render the audio content. In such examples, the satellite playback devices 1104a, 1104b, 1104c form a home theater bonded zone.

In some instances, the primary playback device 1102 and the satellite playback devices 1104a, 1104b, 1104c may render the audio content in lip-synchrony with associated visual content displayed by the display device 1106. In such examples, the primary playback device 1102 may receive the audio content from the display device 1106. For example, the primary playback device 1102 and the display device 1106 can include analog and/or digital interfaces that facilitate communicating the audio content (for example, multichannel audio content) such as a SPDIF RCA interface, an HDMI interface (for example, an audio return channel (ARC) HDMI interface), an optical interface (for example, a TOSLINK interface), and so forth. In such examples, the communication link 1105 may comprise a wired connection (for example, an SPDIF cable, an HDMI cable, a TOSLINK cable, and so forth). In other examples, the primary playback device 1102 and the display device 1106 may include wireless circuitry that facilitates wirelessly communicating the audio content from the display device 1106 to the primary playback device 1102. In such examples, the communication link 1105 may be a wireless communication link such as a WI-FI link, BLUETOOTH link, ZIGBEE link, Z-WAVE link, and/or wireless HDMI link.

After receipt of the audio content associated with visual content to be rendered by the display device 1106, the primary playback device 1102 may communicate the received audio content (or any portion thereof) to the satellite playback devices 1104a, 1104b, 1104c (for example, via the communication links 1103a, 1103b, 1103c). Any of a variety of methodologies may be employed to communicate the audio content to the satellite playback devices 1104a, 1104b, 1104c, including processes that utilize a wireless radio. Once the audio content has been communicated to the satellite playback devices 1104a, 1104b, 1104c, the satellite playback devices 1104a, 1104b, 1104c (and/or the primary playback device 1102) may render the audio content in synchrony with each other and in lip-synchrony with visual content displayed on the display device 1106. For instance, in examples where the primary playback device 1102 is implemented as a soundbar (or otherwise comprises transducers for rendering audio content), the primary playback device 1102 may render the audio content in synchrony with the satellite playback devices 1104a, 1104b, 1104c and in lip-synchrony with the visual content displayed on the display device 1106. In examples where the primary playback device 1102 is implemented as a smart television box or smart television stick (or otherwise does not comprise transducers for rendering audio content), the satellite playback devices 1104a, 1104b, 1104c may render the audio content in synchrony with each other and in lip-synchrony with the display of visual content on the display device 1106 while the primary playback device 1102 may not render the audio content.

In some embodiments, the primary playback device 1102 may also be configured to operate as an access point and/or as a router (for example, a mesh router) that client devices (for example, separate and apart from devices in the home theater environment 1100) may be able to connect to for network access (for example, access to a Wide Area Network (WAN) such as the Internet). For instance, the primary playback device 1102 may be configured as a wireless mesh router that integrates into a mesh router system to extend the range of the mesh router system. Such mesh router systems are becoming increasingly advantageous with the deployment of countless Internet-of-Things (IoT) devices in spaces (for example, residential and/or commercial spaces).

In some embodiments, one of the satellite playback devices, for example playback device 1104a, may also be configured to operate outside of the home theater environment. For instance, the playback device 1104a may communicate directly with the user device 1110 over the communication link 1120a, which may be implemented as a BLUETOOTH network or other suitable PAN. In such instances, the user device 1110 may communicate or stream audio content over the communication link 1120a for playback by the playback device 1104a. The playback device 1104a may be configured to operate in either mode, for example in WI-FI mode as part of the home theater environment 1100 or in BLUETOOTH mode to stream directly from the user device 1110, based on user selectable preferences.

In some embodiments, two or more satellite playback devices, for example 1104a and 1104b may be configured to operate in BLUETOOTH mode to provide a grouping outside of the home theater environment 1100. For instance, the playback device 1104a may stream audio content directly from the user device 1110, using BLUETOOTH over the communication link 1120a as described above, and then stream some portion of that audio content to the playback device 1104b over the BLUETOOTH communication link 1120b. In this manner, for example, the playback device 1104a may play back a first group of one or more channels of multi-channel audio content and the playback device 1104b may play back a second group of one or more channels of multi-channel audio content.

FIG. 12 illustrates devices of the home theater environment 1100 (FIG. 11) that are configured to transition between distinct network connection states (1200A-1200C) in support of swap operations. As shown in FIG. 12, the system 1200 includes a primary playback device 1102, a satellite playback device 1104a, and a control device 1110 (rendered in dashed lines to indicate its optionality).

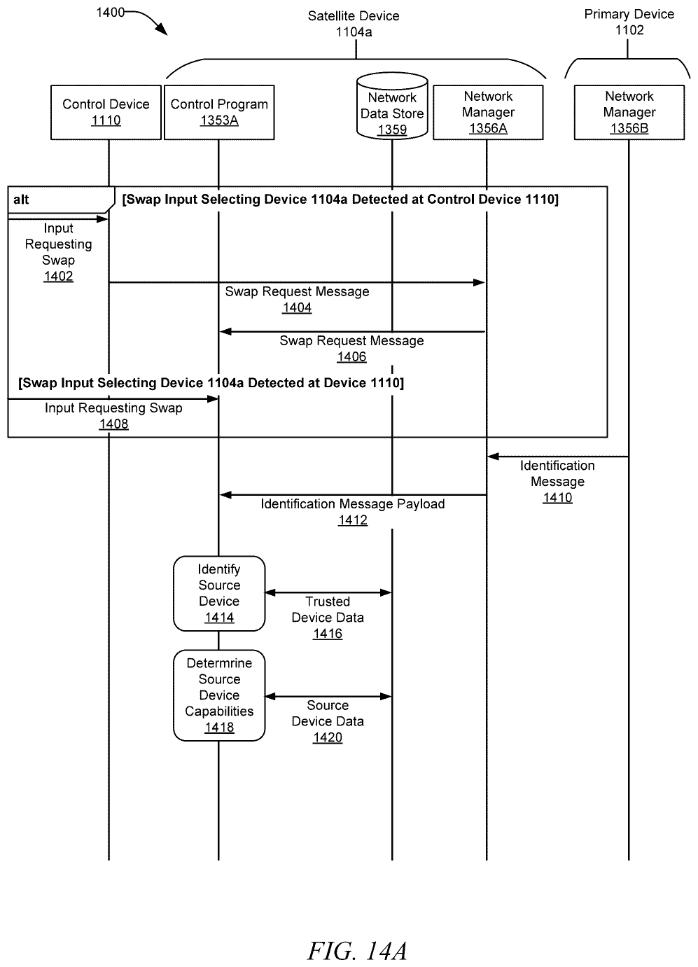

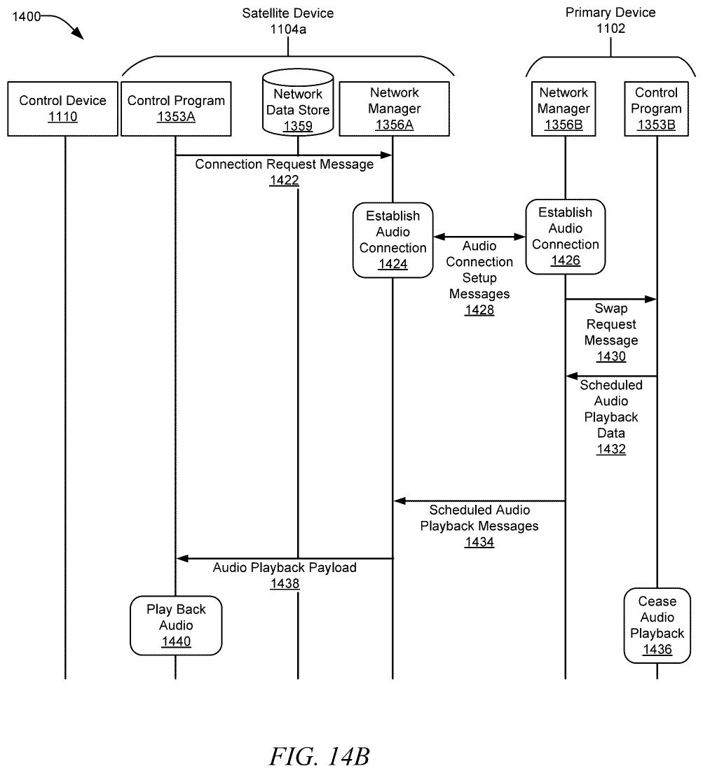

As illustrated in FIG. 12, when the system 1200 is in the network state 1200A, the primary playback device 1102 and the satellite playback device 1104a are paired 1240 and share a trusted relationship established and supported by the BLUETOOTH protocol. Further, in the network state 700A, the control device 1210 (when present) has a WI-FI connection 1220 with the primary playback device 1102 and/or a BLUETOOTH connection with the satellite device 1104a. Within the network state 700A, the primary playback device 1102 and the satellite playback device 1104a are unable to communicate application data to one another as no data plane connection exists between the two, but one or both of the primary playback device 1102 and the satellite playback device 1104a can communicate with the control device 1110, when the control device 1110 is present. However, the primary playback device 1102 and the satellite playback device 1104a can beacon other devices via advertisements, as will be discussed in greater detail below. By executing a process that utilizes these advertisements or other identification messages, the primary playback device 1102 and the satellite playback device 1104a can transition the network state of the system 1200 from the network state 1200A to either the network state 1200B or the network state 1200C depending on the configuration and capabilities of the primary playback device 1102 and the satellite playback device 1104a. Examples of such processes are described further below with reference to FIGS. 14A-16.

Continuing with examples illustrated by FIG. 12, when the system 1200 is in the network state 1200B, the primary playback device 1102 and the satellite playback device 1104a are connected via a BLE audio connection 1250. Similarly, when the system 1200 is in the network state 1200C, the playback devices are connected via a WI-FI audio connection 1260. For instance, the primary playback device 1102 and the satellite playback device 1104a may have executed one of processes 1400-1600 described below to establish a TCP or UDP connection with each other.

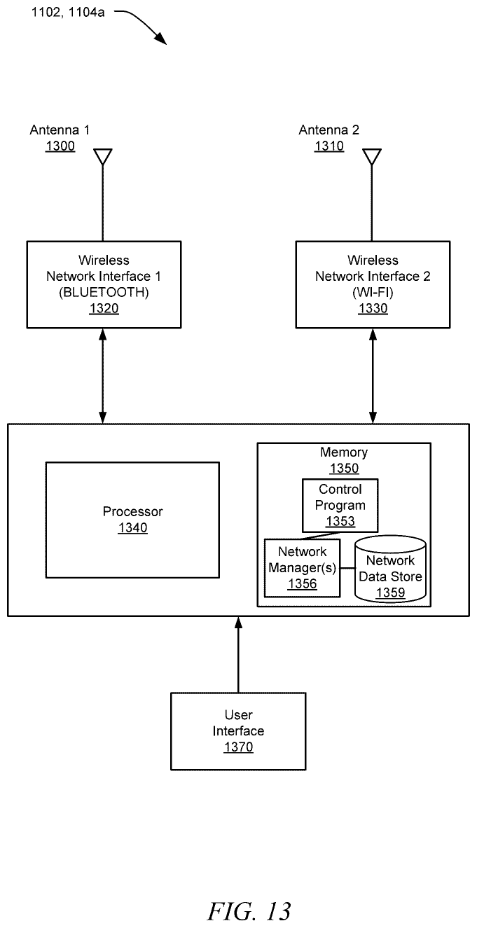

Turning now to FIG. 13, a schematic diagram of a playback device 1102, 1104a (FIG. 11) is illustrated. For example, the playback device may be configured to communicate over either of two network interfaces based on default settings and user selection. As illustrated in FIG. 13, the playback device may include, among other things, a first network interface 1320 coupled to a first antenna 1300, a second network interface 1330 coupled to a second antenna 1310, a processor 1340, memory 1350, and a user interface 1370. The memory 1350 may store a control program 1353, a network manager 1356, and a network data store 1359. The processes that the control program 1353 and the network manager 1356 are configured to execute with reference to data stored in the network data store 1359 are described below with reference to FIGS. 14A-16. Fewer, additional, or alternative components can be included in other implementations.

In some embodiments, one of the network interfaces (e.g., the first network interface 1320) may be configured to communicate via BLUETOOTH and the other network interface (e.g., the second network interface 1330) may be configured to communicate via WI-FI. The wireless network interfaces 1320 and 1330 can include, among other things, a transmit buffer, transmitter circuitry, a receive buffer, and receiver circuitry. The wireless network interfaces 1320 and 1330 can correspond to or include the capability of the wireless interface 112e (FIG. 1) described above.

In some embodiments, the user interface 1370 may include one or more buttons or other mechanisms configured to enable the user to provide input to and/or otherwise control the playback device 1302, including selection of network connection and volume control.

The processor 1340 includes clock-driven circuitry configured to execute instructions (e.g., code, such as the control program 1353 and the network manager 1356) stored in a non-transitory computer-readable medium such as the memory 1350. The processor 1340 can correspond to or include the capabilities of the processor 112a (FIG. 1) described above. For example, the processor 1340 can be configured to execute instructions such that the playback device is configured to execute a process for transitioning network connections, as will be described in greater detail below.

FIG. 14A illustrates another swapping process 1400 that the devices introduced in FIG. 11 are configured to execute, in some examples. As shown in FIG. 14A, the process 1400 starts with either the control device 1110 receiving input 1402 requesting a swap operation between the primary playback device 1102 and the satellite playback device 1104a, or a first instance of the control program 1353A hosted by the satellite device 1104a receiving input 1408 requesting the swap operation. For example, the input 1408 may include an actuation of a button of the satellite device 1104a that is designated to initiate the swap operation. The button may be part of a user interface of the satellite device 1104a, such as the user interface 113 (FIG. 1C). The input 1408 may be or include some other gesture and/or a voice command to initiate the swap operation.

Alternatively or additionally, in some examples, the control device 1110 receives input 1402 requesting the swap operation. For instance, where the control device 1110 includes a touchscreen, the input 1402 may be a selection of a control, such as a virtual button, rendered via the touchscreen by a control application executed by the control device 1110. The input 1402 may also include a voice command detected by the control device 1110. Other examples of the input 1402, 1408 that may be detected by the satellite device 1104a and/or the control device 1110 will be apparent in view of this disclosure.

Continuing with the process 1400, if the control device 1110 detects the input 1402, the control device 1110 generates and communicates a message 1404 to a first instance of the network manager 1356A hosted by the satellite playback device 1104a. The message 1404 may specify a request to initiate a swap operation. For instance, the message 1404 may be an API call transmitted by the control device 1110 to the satellite playback device 1104a via a BLUETOOTH connection (e.g., 1230 of FIG. 12). Alternatively, if the satellite playback device 1104a and the control device 1110 are connected via WI-FI, the message may be an API call communicated via a WI-FI connection. The network manager 1356A, in turn, generates a message 1406 that specifies a request to execute a swap operation and communicates the message 1406 to the control program 1353A.

Continuing with the process 1400, in response to receiving the input 1408 and/or the message 1406, the control program 1353A initiates the requested swap operation by identifying 1414 a source playback device from which the satellite playback device 1104a is to receive audio data after the swap operation is complete. FIG. 17 illustrates one example of a device identification process 1700 executed by the control program 1353A and the network manager 1356A in some examples. As shown in FIG. 17, the process 1700 starts with the control program 1353A scanning 1702 for identification messages. For instance, in some examples of the operation 1414, the control program 1353A scans, via interoperation with the network manager 1356A, for identification messages transmitted by other playback devices proximal to the satellite playback device 1104a. In these examples, the network manager 1356A is configured to drive operation of one or more integrated network interfaces (e.g., 1320, 1330 of FIG. 13) to receive identification messages, parse the messages to extract a payloads specified within and pass the payloads to the control program 1353A for subsequent processing. These identification messages may include, for example, BLUETOOTH or WI-FI advertisement messages with a payload that specifies a playback device identifier, such as a serial number or a model number, that indicates attributes of connection supported by the playback device. The duration of the scan may vary between examples. For instance, in some examples, the control program 1353A continues to scan until a timeout (e.g., up to 5 seconds) occurs or until at least one identification message that originated from a trusted playback device is detected, as discussed below. In other examples, the control program 1353A scans for a fixed time period (e.g. 1 second, 2 seconds, 3 seconds, or another duration up to 5 seconds) to collect potentially multiple identification messages for subsequent processing.

Continuing with the process 1700, the control program 1353A determines 1704 whether at least one identification message was detected via execution of the scanning operation 1702. If the control program 1353A determines that no identification message was detected, the control program 1353A may terminate this instance of the process 1700. If the control program 1353A determines at at least one identification message was detected, the control program 1353A proceeds to operation 1706.

As shown in FIG. 14A, the network manager 1356A receives an identification message 1410 from a second, distinct instance of the network manager 1356B hosted by the primary playback device 1102. The network manager 1356A parses the identification message 1410 to extract a payload 1412 and passes the payload 1412 to the control program 1353A for subsequent processing.

Continuing with the process 1700, the control program 1353A selects 1706 the next identification message not yet processed by this instance of the process 1700 and determines 1708 whether the selected message originated from a trusted device. For instance, in these examples, the control program 1353A parses each detected identification message to extract an identifier of a device that originated the message. Further, in these examples, the control program 1353A searches a locally stored list of identifiers of trusted playback devices for an identifier that matches (e.g., is the same as) the extracted identifier. This list of identifiers may be stored in the network data store 1359 as a table or other data structure. The network data store 1359 may reside physically within local memory (e.g., 850 of FIG. 8), although this is not a requirement. As such, in some examples, the control program 1353A retrieves trusted device data 1416 from the network data store 1359 when searching for an identifier that matches the extracted identifier. If a match is found, the control program 1353A records 1710 (e.g., in the data store 1359) the trusted playback device identified by the extracted identifier as a candidate source playback device and proceeds to the operation 1712. If no match is found, the control program 1353A disregards the identification message and proceeds to the operation 1712.

Continuing with the process 1700, the control program 1353A determiners 1712 whether any identification message detected via the scanning operation 1702 remains unprocessed by this instance of the process 1700. If unprocessed messages remain, the control program 1353A returns to the operation 1706 and selects 1706 the next, unprocessed message for processing. If no unprocessed messages remain, the control program 1353A proceeds to operation 1714.

Continuing with the process 1700, the control program 1353A selects 1714 a source device from the candidate devices. In certain examples, the control program 1353A selects the first candidate playback device to be identified as a source playback device for the swap operation. Alternatively or additionally, if multiple candidates are identified, the control program 1353A determines a proximity of each candidate to the satellite device 1104a and selects the closest candidate as the source playback device. In some examples, the control program 1353A determines proximity of each candidate by analyzing a strength of a signal that conveyed the identification message from the candidate. This analysis of signal strength may include calculation of a signal to noise ratio. Alternatively or additionally, in some examples, each identification message may specify a transmit power of the signal conveying the message and the control program 1353A may calculate an amount of signal attenuation as an indicator of proximity. These and other signal strength metrics that can be used to determine relative distance between playback devices will be apparent in view of this disclosure. Additionally or alternatively, within the operation 1010, the control program 1353A may use acoustic signaling techniques to determine relative proximity of candidates. Examples of playback devices equipped with ultrasonic presence detection are disclosed in U.S. Patent Publication Nos. 2022/0066008 and 2022/0261212, each of which is hereby incorporated herein by reference in its entirety for all purposes. In these examples, the control program 1353A controls the satellite device 1104a to transmit an unsolicited acoustic signal and calculates a turnaround time between transmission and reception of a responsive acoustic signal from each candidate device. The turnround time for each candidate device provides an estimate of relative distance between the satellite device 1104a and the candidate device.

Subsequent to the operation 1714, the process 1700 may end.

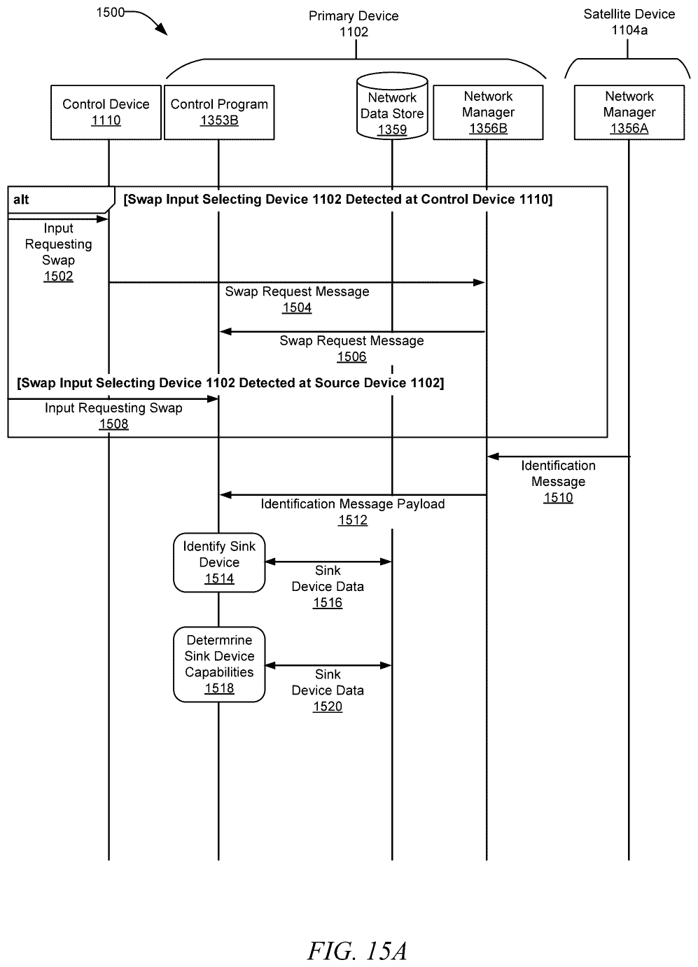

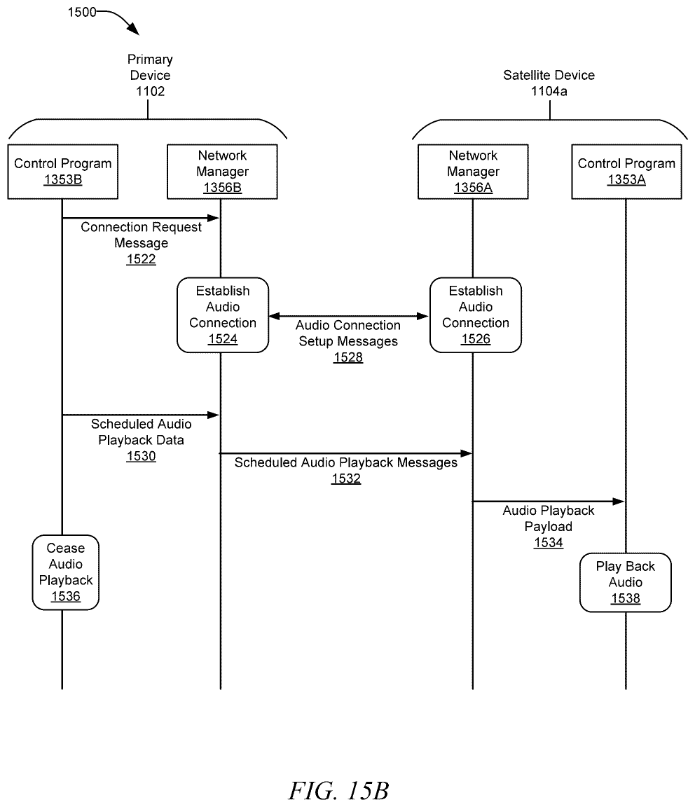

It should be noted that the process 1700 described above may also be executed by the control program 1353B and the network manager 1356B to identify a sink device, as is illustrated as operation 1514 in FIG. 15A and described further below. In this situation, the description of the process 1700 applies, but with the control program 1353A and the network manager 1356A of the second playback device being substituted with the control program 1353B and the network manager 1356B of the first playback device.

As shown in FIG. 14A, the control program 1353A receives the identification message payload 1412 from the network manager 1356A. The control program 1353A processes the identification message payload 1412 with reference to the trusted device data 1416 to select the primary playback device 1102 as a source playback device for the swap operation.

Continuing with the process 1400, the control program 1353A determines 1418 capabilities of the source playback device selected in operation 1414. These determined capabilities may include, for example, connection attributes, such as the types of networks (e.g., LANs, PANs, etc.) and network connections (TCP, UDP, BLUETOOTH, BLE audio, etc.) that the source playback device supports. For instance, some source playback devices of a first type may support BLUETOOTH identification messages, but not BLUETOOTH or BLE audio connections, while source playback devices of a second type may support both BLUETOOTH identification messages and BLUETOOTH or BLE audio connections. The control program 1353A may interoperate with source playback devices of the first type to establish an audio connection that is not a BLUETOOTH connection (e.g., a WI-FI connection). The control program 1353A may interoperate with source playback devices of the second type to establish an audio connection that is a BLUETOOTH connection.

In some examples, the control program 1353A determines connection attributes supported by a source playback device by extracting supported connection attributes associated with the source playback device from a local data store (e.g., the data store 1359) keyed on an identifier of the source playback device (e.g., serial number, model number etc.). Alternatively or additionally, the control program 1353A may extract supported connection attributes from identification messages or connection setup messages specifying the same. Connection setup messages are described further below with reference to operations 1424 and 1426, which are illustrated FIG. 14B.

Continuing with the process 1400 with reference to FIG. 14B, the control program 1353A generates a message 1422 specifying a request to establish an audio connection between the satellite device 1104a and the source playback device and communicates the message 1422 to the network manager 1356A. The network manager 1356A, in turn, processes the message 1422 and, in response thereto, interoperates with the network manager 1356B to establish 1424, 1426 a preferred audio connection. As shown in FIG. 14A, this interoperation involves exchanging a plurality of setup messages 1428. The information specified within the setup messages 1428 depends on a variety of factors. These factors may include the type of network and network connection preferred for audio and the capabilities of the satellite playback device 1104a and the source playback device. In at least one example, a BLE audio connection is preferred to conserve energy consumed by the source playback device and the satellite playback device 1104a after the swap operation is complete. The setup messages 1428 may further specify operational parameters (e.g., parameters specifying volume level and equalizer settings, among others) that effect playback of audio content by the satellite playback device 1104a. In addition, the setup messages 1428 may include a message 1430 specifying a request for the source playback device to participate in the swap operation. The network manager 1356B may pass the message 1430 to a second instance of the control program 1353B hosted by the source playback device. Other content that may be specified in the setup messages 1428 will be apparent in view of this disclosure.

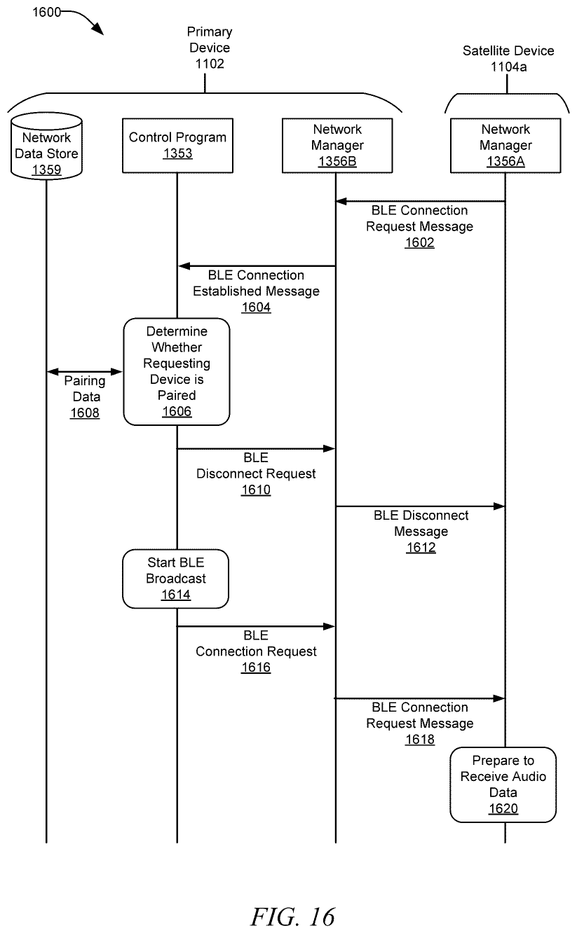

In one example illustrated in FIG. 14A, the network manager 1356A and the network manager 1356B control their respective host devices to establish a BLE audio connection (e.g., 1250 of FIG. 12). One example of a process that the primary playback device 1102 and the satellite device 1104a are configured to execute to establish the BLE audio connection is described further below with reference to FIG. 16.

Continuing with the process 1400, after the audio connection is established and the control program 1353B processes the swap request message 1430, the control program 1353B generates audio data 1432 scheduled for playback by the satellite device 1104a and passes the audio data 1432 to the network manager 1356B for communication to the network manager 1356A. The network manager 1356B packages the audio data 1432 into messages 1434 and transmits the messages 1434 to the network manager 1356A. The network manager 1356A receives and processes the playback messages 1434. This processing may include parsing the playback messages 1434 to extract an audio playback payload 1438 and passing the audio playback payload 1438 to the control program 1353A for subsequent processing. The control program 1353A, in turn, may process the playback payload 1438 to play back 1440 audio content according to the schedule specified therein. In some examples illustrated by FIG. 14A, the control program 1353B controls the source playback device to cease 1436 audio playback after initial transmission of at least one of the messages 1434. In certain examples, the control program 1353B controls the source playback device to ceases 1436 audio playback in synchrony with the start of playback by the satellite playback device 1104a. Additional details regarding the scheduling and playing back audio content are described in U.S. Pat. No. 8,234,395, cited above.

It should be noted that the swap operation resulting from execution of the process 1400 can be reversed as follows, in some examples. The control program 1353A may receive input or a message from the control device 1110 requesting the reversal and, in response thereto, may communicate a reversal request to the control program 1353B via the network managers 1356A and 1356B. The control program 1353B may process the reversal request to cease generation and transmission of the messages 1434, tear down of the audio connection established by the operations 1424 and 1426, and control the primary playback device 1102 to resume playback of the audio content. In some examples, the control program 1353B may synchronize resumption of playback of the audio content with cessation of playback of the audio content by the satellite playback device 1104a.

FIG. 15A illustrates another swapping process 1500 that the devices introduced in FIG. 11 are configured to execute, in some examples. As shown in FIG. 15A, the process 1500 starts with either the control device 1110 receiving input 1502 requesting a swap operation between the primary playback device 1102 and the satellite playback device 1104a, or a first instance of the control program 1353B hosted by the primary playback device 1102 receiving input 1508 requesting the swap operation. For example, the input 1508 may include an actuation of a button of the primary playback device 1102 that is designated to initiate the swap operation. The button may be part of a user interface of the primary playback device 1102, such as the user interface 113 (FIG. 1C). The input 1508 may be or include some other gesture and/or a voice command to initiate the swap operation.

Alternatively or additionally, in some examples, the control device 1110 receives input 1502 requesting the swap operation. For instance, where the control device 1110 includes a touchscreen, the input 1502 may be a selection of a control, such as a virtual button, rendered via the touchscreen by a control application executed by the control device 1110. The input 1502 may also include a voice command detected by the control device 1110. Other examples of the input 1502, 1508 that may be detected by the primary playback device 1102 and/or the control device 1110 will be apparent in view of this disclosure.

Continuing with the process 1500, if the control device 1110 detects the input 1502, the control device 1110 generates and communicates a message 1504 to a first instance of the network manager 1356B hosted by the primary playback device 1102. The message 1504 may specify a request to initiate a swap operation. For instance, the message 1504 may be an API call transmitted by the control device 1110 to the primary playback device 1102 via a BLUETOOTH connection (e.g., 1230 of FIG. 12). Alternatively, if the primary playback device 1102 and the control device 1110 are connected via WI-FI, the message may be an API call communicated via a WI-FI connection. The network manager 1356B, in turn, generates a message 1506 that specifies a request to execute a swap operation and communicates the message 1506 to the control program 1353B.

Continuing with the process 1500, in response to receiving the input 1508 and/or the message 1506, the control program 1353B initiates the requested swap operation by identifying 1514 a sink playback device to which the primary playback device 1102 is to communicate audio data after the swap operation is complete. For instance, in some examples of the operation 1514, the control program 1353B scans, via interoperation with the network manager 1356B, for identification messages transmitted by other playback devices proximal to the primary playback device 1102. In these examples, the network manager 1356B is configured to drive operation of one or more integrated network interfaces (e.g., 1320, 1330 of FIG. 13) to receive identification messages, parse the messages to extract a payloads specified within and pass the payloads to the control program 1353B for subsequent processing. These identification messages may include, for example, BLUETOOTH or WI-FI advertisement messages with a payload that specifies a playback device identifier, such as a serial number or a model number, that indicates attributes of connection supported by the playback device. The duration of the scan may vary between examples. For instance, in some examples, the control program 1353B continues to scan until a timeout (e.g., up to 5 seconds) occurs or until at least one identification message that originated from a trusted playback device is detected, as discussed below. In other examples, the control program 1353B scans for a fixed time period (e.g. 1 second, 2 seconds, 3 seconds, or another duration up to 5 seconds) to collect potentially multiple identification messages for subsequent processing.

As shown in FIG. 15A, the network manager 1356B receives an identification message 1510 from a second, distinct instance of the network manager 1356A hosted by the satellite playback device 1104a. The network manager 1356B parses the identification message 1510 to extract a payload 1512 and passes the payload 1512 to the control program 1353B for subsequent processing.

Further, in some examples of the operation 1514, the control program 1353B determines whether any detected identification messages originated from a trusted playback device. For instance, in these examples, the control program 1353B parses each detected identification message to extract an identifier of a device that originated the message. Further, in these examples, the control program 1353B searches a locally stored list of identifiers of trusted playback devices for an identifier that matches (e.g., is the same as) the extracted identifier. This list of identifiers may be stored in the network data store 1359 as a table or other data structure. The network data store 1359 may reside physically within local memory (e.g., 850 of FIG. 8), although this is not a requirement. As such, in some examples, the control program 1353B retrieves trusted device data 1516 from the network data store 1359 when searching for an identifier that matches the extracted identifier. If a match is found, the control program 1353B records (e.g., in the data store 1359) the trusted playback device identified by the extracted identifier as a candidate sink playback device. If no match is found, the control program 1353B disregards the identification message.

In certain examples of the operation 1514, the control program 1353B selects the first candidate playback device to be identified as a sink playback device for the swap operation. Alternatively or additionally, if multiple candidates are identified, the control program 1353B determines a proximity of each candidate to the primary playback device 1102 and selects the closest candidate as the sink playback device. In some examples, the control program 1353B determines proximity of each candidate by analyzing a strength of a signal that conveyed the identification message from the candidate. This analysis of signal strength may include calculation of a signal to noise ratio. Alternatively or additionally, in some examples, each identification message may specify a transmit power of the signal conveying the message and the control program 1353B may calculate an amount of signal attenuation as an indicator of proximity. These and other signal strength metrics that can be used to determine relative distance between playback devices will be apparent in view of this disclosure. Additionally or alternatively, within the operation 1010, the control program 1353B may use acoustic signaling techniques to determine relative proximity of candidates. Examples of playback devices equipped with ultrasonic presence detection are disclosed in U.S. Patent Publication Nos. 2022/0066008 and 2022/0261212, each of which is hereby incorporated herein by reference in its entirety for all purposes. In these examples, the control program 1353B controls the primary playback device 1102 to transmit an unsolicited acoustic signal and calculates a turnaround time between transmission and reception of a responsive acoustic signal from each candidate device. The turnround time for each candidate device provides an estimate of relative distance between the primary playback device 1102 and the candidate device.

As shown in FIG. 15A, the control program 1353B receives the identification message payload 1512 from the network manager 1356B. The control program 1353B processes the identification message payload 1512 with reference to the trusted device data 1516 to select the satellite playback device 1104a as a sink playback device for the swap operation.

Continuing with the process 1500, the control program 1353B determines 1518 capabilities of the sink playback device selected in operation 1514. These determined capabilities may include, for example, connection attributes, such as the types of networks (e.g., LANs, PANs, etc.) and network connections (TCP, UDP, BLUETOOTH, BLE audio, etc.) that the sink playback device supports. For instance, some sink playback devices of a first type may support BLUETOOTH identification messages, but not BLUETOOTH or BLE audio connections, while sink playback devices of a second type may support both BLUETOOTH identification messages and BLUETOOTH OR BLE audio connections. The control program 1353B may interoperate with sink playback devices of the first type to establish an audio connection that is not a BLUETOOTH connection (e.g., a WI-FI connection). The control program 1353B may interoperate with sink playback devices of the second type to establish an audio connection that is a BLUETOOTH connection.

In some examples, the control program 1353B determines connection attributes supported by a sink playback device by extracting supported connection attributes associated with the sink playback device from a local data store (e.g., the data store 1359) keyed on an identifier of the sink playback device (e.g., serial number, model number etc.). Alternatively or additionally, the control program 1353B may extract supported connection attributes from identification messages or connection setup messages specifying the same. Connection setup messages are described further below with reference to operations 1524 and 1526, which are illustrated FIG. 15B.

Continuing with the process 1500 with reference to FIG. 15B, the control program 1353B generates a message 1522 specifying a request to establish an audio connection between the satellite device 1104a and the sink playback device and communicates the message 1522 to the network manager 1356B. The network manager 1356B, in turn, processes the message 1522 and, in response thereto, interoperates with the network manager 1356A to establish 1524, 1526 a preferred audio connection. As shown in FIG. 15A, this interoperation involves exchanging a plurality of setup messages 1528. The information specified within the setup messages 1528 depends on a variety of factors. These factors may include the type of network and network connection preferred for audio and the capabilities of the primary playback device 1102 and the sink playback device. In at least one example, a BLE audio connection is preferred to conserve energy consumed by the sink playback device and the primary playback device 1102 after the swap operation is complete. The setup messages 1528 may further specify operational parameters (e.g., parameters specifying volume level and equalizer settings, among others) that effect playback of audio content by the satellite playback device 1104a. In addition, the setup messages 1528 may include a message specifying a request for the sink playback device to participate in the swap operation. The network manager 1356A may pass the message to a second instance of the control program 1353A hosted by the sink playback device. Other content that may be specified in the setup messages 1528 will be apparent in view of this disclosure.

In one example illustrated in FIG. 15A, the network manager 1356B and the network manager 1356A control their respective host devices to establish a WI-FI audio connection (e.g., 1260 of FIG. 12).

Continuing with the process 1500, after the audio connection is established, the control program 1353B generates audio data 1530 scheduled for playback by the sink playback device and passes the audio data 1530 to the network manager 1356B for communication to the network manager 1356A. The network manager 1356B packages the audio data 1530 into messages 1532 and transmits the messages 1532 to the network manager 1356A. The network manager 1356A receives and processes the playback messages 1532. This processing may include parsing the playback messages 1532 to extract an audio playback payload 1534 and passing the audio playback payload 1534 to the control program 1353A for subsequent processing. The control program 1353A, in turn, may process the playback payload 1534 to play back 1538 audio content according to the schedule specified therein. In some examples illustrated by FIG. 15A, the control program 1353B controls the primary playback device 1102 to cease 1536 audio playback after initial transmission of at least one of the messages 1532. In certain examples, the control program 1353B controls the primary playback device 1102 to ceases 1536 audio playback in synchrony with the start of playback by the sink playback device. Additional details regarding the scheduling and playing back audio content are described in U.S. Pat. No. 8,234,395, cited above.

It should be noted that the swap operation resulting from execution of the process 1500 can be reversed as follows, in some examples. The control program 1353B may receive input or a message from the control device 1110 requesting the reversal and, in response thereto, may communicate a reversal request to the control program 1353A via the network managers 1356B and 1356A. The control program 1353B may further cease generation and transmission of the messages 1532, tear down of the audio connection established by the operations 1524 and 1526, and control the primary playback device 1102 to resume playback of the audio content. In some examples, the control program 1353B may synchronize resumption of playback of the audio content with cessation of playback of the audio content by the satellite playback device 1104a.

FIG. 16 illustrates a process 1600 to establish a BLE audio connection that the devices introduced in FIG. 11 are configured to execute, in some examples. As shown in FIG. 16, the process 1600 starts with a first instance of the network manager 1356A (FIG. 13) hosted on the satellite device 1104a transmitting a message 1602 requesting a BLE connection to a second instance of the network manager 1356B hosted on the primary playback device 1102. In response to reception of the message 1602, the network manager 1356B initially accepts the BLE connection request and communicates a message 1604 to the control program 1353 of the primary playback device 1102.

Continuing with the process 1600, the control program 1353 determines 1606 whether the satellite playback device 1104a has been previously paired with the primary playback device 1102. For instance, in some examples, the control program 1353 searches a list of devices that previously paired with the primary playback device 1102 via BLUETOOTH. In some examples, this list of devices is stored in the network data store 1359. As such, in these examples, the control program 1353 retrieves BLUETOOTH pairing data 1608 from the network data store when determining whether the satellite playback device 1104a has been previously paired with the primary playback device 1102.

Continuing with the process 1600, the control program 1353 generates a message 1610 specifying a request to disconnect from the satellite device 1104a and communicates the message 1610 to the network manager 1356B. In some examples, the control program 1353 communicates this request regardless of whether a previous pairing between the primary playback device 1102 and the satellite device 1104a exists. The network manager 1356B receives and processes the message 1610. This processing may include generating a message 1612 specifying that the network manager 1356B is disconnecting from the network manager 1356A, communicating the message 1612 to the network manager 1356A, and tearing down the BLE connection between the primary playback device 1102 and the satellite device 1104a.

Continuing with the process 1600, if the control program 1353 previously determined that the satellite device 1104a is paired with the primary playback device 1102, the control program 1353 initiates 1614 a BLE audio broadcasting session. The control program 1353 generates a message 1616 specifying a request to establish a BLE audio connection with the satellite device 1104a and communicates the message 1616 to the network manager 1356B. The network manager 1356B generates a message 1618 specifying a request to establish a BLE audio connection and transmits the message 1618 to the network manager 1356A. The network manager 1356A receives the message 1618 and, in response, prepares 1620 to receive audio data via the BLE audio broadcasting session.

Execution of the process 1600 enables the primary playback device 1102 to initiate a traffic bearing BLE audio connection with the satellite device 1104a. By initiating the BLE audio connection, the primary playback device 1102 can better control scheduling of broadcast packets.

### VI. Conclusion

The above discussions relating to playback devices, controller devices, playback zone configurations, and media content sources provide only some examples of operating environments within which functions and methods described herein may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Example Features

The following examples pertain to further embodiments, from which numerous permutations and configurations will be apparent.

Example 1 is directed to a first playback device. The first playback device includes a user interface; a plurality of network interfaces including a personal area network (PAN) interface and a local area network (LAN) interface; at least one processor; and at least one non-transitory computer-readable medium. The medium stores program instructions that are executable by the at least one processor such that the first playback device is configured to: detect input via the user interface specifying a request to establish a network connection between the first playback device and a second playback device; detect, via the PAN interface, a message from the second playback device, the message specifying an identifier of the second playback device; identify connection attributes associated with the second playback device; establish, via one of the plurality of network interfaces, a connection with the second playback device based on the connection attributes; and play back audio content received via the connection to the second playback device.

Example 2 includes the subject matter of example 1, wherein: the connection attributes specify a connection type supported by the second playback device; and to establish the connection comprises to extract the connection type from the connection attributes.

Example 3 includes the subject matter of example 2, wherein the connection type is either a PAN connection type or a LAN connection type.

Example 4 includes the subject matter of example 3, wherein: the PAN interface is configured to facilitate communication using at least one BLUETOOTH communication protocol; the LAN interface is configured to facilitate communication using at least one WI-FI communication protocol; and the connection type is either a BLUETOOTH connection type or a WI-FI connection type.

Example 5 includes the subject matter of example 4, wherein the PAN interface comprises a BLUETOOTH low energy (BLE) interface.

Example 6 includes the subject matter of example 5, wherein the message comprises a BLE advertisement.

Example 7 includes the subject matter of example 6, wherein to establish the connection with the second playback device comprises to determine that a first distance between the first playback device and the second playback device is less than a second distance between the first playback device and a third playback device.

Example 8 includes the subject matter of example 7, wherein the program instructions further comprise program instructions to estimate the first distance based on a comparison of a power of a signal conveying the BLE advertisement to a transmission power stored in the BLE advertisement.

Example 9 includes the subject matter of any of examples 1-8, wherein: the first playback device comprises headphones; the user interface comprises a button; and to detect the input comprises to receive an indication of actuation of the button.

Example 10 includes the subject matter of any of examples 1-9, wherein the program instructions further comprise program instructions to, after establishing the connection with the second playback device: terminate the connection with the second playback device; accept a new connection with the second playback device, the new connection established by the second playback device; and playing back audio content received via the new connection to the second playback device.

Example 11 includes the subject matter of any of examples 1-10, wherein the program instructions further comprise program instructions to, after establishing the connection with the second playback device, exchange volume control information between the first playback device and the second playback device.

Example 12 is directed to a system. The system includes a first playback and a second playback device. The first playback device is configured to detect input via a user interface specifying a request to establish a network connection between the first playback device and a second playback device, detect, via a first PAN interface, a message from the second playback device, the message specifying an identifier of the second playback device, identify connection attributes associated with the second playback device, and establish, via one of a plurality of network interfaces, a first connection with the second playback device based on the connection attributes. The second playback device is configured to tear down the first connection, and establish, via a second PAN interface, a second connection with the first playback device.

Example 13 includes the subject matter of example 12, wherein: the connection attributes specify a connection type supported by the second playback device; and to establish the first connection comprises to extract the connection type from the connection attributes.

Example 14 includes the subject matter of example 13, wherein: the plurality of network interfaces comprises the first PAN interface and a local area network (LAN) interface; and
the connection type is either a PAN connection type or a LAN connection type.

Example 15 includes the subject matter of example 14, wherein: the first PAN interface is configured to facilitate communication using at least one BLUETOOTH communication protocol; the second PAN interface is configured to facilitate communication using at least one BLUETOOTH communication protocol; the LAN interface is configured to facilitate communication using at least one WI-FI communication protocol; and the connection type is either a BLUETOOTH connection type or a WI-FI connection type.

Example 16 includes the subject matter of example 15, wherein the PAN interface comprises a BLUETOOTH low energy (BLE) interface.

Example 17 includes the subject matter of example 16, wherein the message comprises a BLE advertisement.

Example 18 includes the subject matter of example 17, wherein the second playback device is further configured to determine whether an identifier of the first playback device is stored in a list of devices previously paired with the second playback device.

Example 19 includes the subject matter of example 18, wherein the second playback device is configured to start a BLE broadcast session after tear down of the first connection and prior to establishment of the second connection.

Example 20 includes the subject matter of example 19, wherein: the second playback device is configured to communicate a copy of audio data to the first playback device via the second connection; and the first playback device is configured to play back audio content based on the copy of the audio data.

Example 21 includes the subject matter of any of examples 12-20, wherein to establish the first connection with the second playback device comprises to determine that a first distance between the first playback device and the second playback device is less than a second distance between the first playback device and a third playback device.

Example 22 includes the subject matter of any of examples 12-21, wherein: the first playback device comprises headphones; the second playback device comprises a sound bar; the user interface comprises a button; and to detect the input comprises to receive an indication of actuation of the button.

Example 23 includes the subject matter of any of examples 12-23, wherein the first playback device is configured to exchange volume control information with the second playback device.

Example 24 is directed to a method for operating a first playback device. The method includes detecting input, via a user interface of the first playback device, the input specifying a request to establish a network connection between the first playback device and a second playback device; detecting, via a PAN interface of the first playback device, a message from the second playback device, the message specifying an identifier of the second playback device; identifying connection attributes associated with the second playback device; establishing, via one of a plurality of network interfaces of the first playback device, a connection with the second playback device based on the connection attributes; and playing back audio content received via the connection to the second playback device.

Example 25 includes the subject matter of example 24, wherein: the connection attributes specify a connection type supported by the second playback device; and establishing the connection comprises extracting the connection type from the connection attributes.

Example 26 includes the subject matter of example 25, wherein the connection type is either a PAN connection type or a local area network (LAN) connection type.

Example 27 includes the subject matter of example 26, wherein: the plurality of network interfaces of the first playback device comprises the PAN interface and a LAN interface; the PAN interface is configured to facilitate communication using at least one BLUETOOTH communication protocol; the LAN interface is configured to facilitate communication using at least one WI-FI communication protocol; and the connection type is either a BLUETOOTH connection type or a WI-FI connection type.

Example 28 includes the subject matter of example 27, wherein the PAN interface comprises a BLUETOOTH low energy (BLE) interface.

Example 29 includes the subject matter of example 28, wherein the message comprises a BLE advertisement.

Example 30 includes the subject matter of example 29, wherein establishing the connection with the second playback device comprises determining that a first distance between the first playback device and the second playback device is less than a second distance between the first playback device and a third playback device.

Example 31 includes the subject matter of example 30, further comprising estimating the first distance based on a comparison of a power of a signal conveying the BLE advertisement to a transmission power stored in the BLE advertisement.

Example 32 includes the subject matter of any of examples 24-31, further comprising: terminating the connection with the second playback device; accepting a new connection with the second playback device, the new connection established by the second playback device; and playing back audio content received via the new connection to the second playback device.

Example 33 includes the subject matter of any of examples 24-32, further comprising, after establishing the connection with the second playback device, exchanging volume control information between the first playback device and the second playback device.

What is claimed is:

1. A first playback device comprising:
a user interface;
a plurality of network interfaces comprising a personal area network (PAN) interface and a local area network (LAN) interface;
at least one processor; and
at least one non-transitory computer-readable medium comprising program instructions that are executable by the at least one processor such that the first playback device is configured to:
detect input via the user interface specifying a request to establish a network connection between the first playback device and a second playback device,
detect, via the PAN interface, a message from the second playback device, the message specifying an identifier of the second playback device,
identify connection attributes associated with the second playback device,
establish, via one of the plurality of network interfaces, a connection with the second playback device based on the connection attributes, and
play back audio content received via the connection to the second playback device.

2. The first playback device of claim 1, wherein:
the connection attributes specify a connection type supported by the second playback device; and
to establish the connection comprises to extract the connection type from the connection attributes.

3. The first playback device of claim 2, wherein the connection type is either a PAN connection type or a LAN connection type.

4. The first playback device of claim 3, wherein:
the PAN interface is configured to facilitate communication using at least one BLUETOOTH communication protocol;
the LAN interface is configured to facilitate communication using at least one WI-FI communication protocol; and
the connection type is either a BLUETOOTH connection type or a WI-FI connection type.

5. The first playback device of claim 4, wherein the PAN interface comprises a BLUETOOTH low energy (BLE) interface.

6. The first playback device of claim 5, wherein the message comprises a BLE advertisement.

7. The first playback device of claim 6, wherein to establish the connection with the second playback device comprises to determine that a first distance between the first playback device and the second playback device is less than a second distance between the first playback device and a third playback device.

8. The first playback device of claim 7, wherein the program instructions further comprise program instructions to estimate the first distance based on a comparison of a power of a signal conveying the BLE advertisement to a transmission power stored in the BLE advertisement.

9. The first playback device of claim 1, wherein:
the first playback device comprises headphones;
the user interface comprises a button; and
to detect the input comprises to receive an indication of actuation of the button.

10. The first playback device of claim 1, wherein the program instructions further comprise program instructions to, after establishing the connection with the second playback device:
terminate the connection with the second playback device;
accept a new connection with the second playback device, the new connection established by the second playback device; and
playing back audio content received via the new connection to the second playback device.

11. The first playback device of claim 1, wherein the program instructions further comprise program instructions to, after establishing the connection with the second playback device, exchange volume control information between the first playback device and the second playback device.

12. A system comprising:
a first playback device configured to
detect input via a user interface specifying a request to establish a network connection between the first playback device and a second playback device,
detect, via a first PAN interface, a message from the second playback device, the message specifying an identifier of the second playback device,
identify connection attributes associated with the second playback device, and
establish, via one of a plurality of network interfaces, a first connection with the second playback device based on the connection attributes; and
the second playback device, the second playback device being configured to:
tear down the first connection, and
establish, via a second PAN interface, a second connection with the first playback device.

13. The system of claim 12, wherein:
the connection attributes specify a connection type supported by the second playback device; and
to establish the first connection comprises to extract the connection type from the connection attributes.

14. The system of claim 13, wherein:
the plurality of network interfaces comprises the first PAN interface and a local area network (LAN) interface; and
the connection type is either a PAN connection type or a LAN connection type.

15. The system of claim 14, wherein:
the first PAN interface is configured to facilitate communication using at least one BLUETOOTH communication protocol;
the second PAN interface is configured to facilitate communication using at least one BLUETOOTH communication protocol;
the LAN interface is configured to facilitate communication using at least one WI-FI communication protocol; and
the connection type is either a BLUETOOTH connection type or a WI-FI connection type.

16. The system of claim 15, wherein the PAN interface comprises a BLUETOOTH low energy (BLE) interface.

17. The system of claim 16, wherein the message comprises a BLE advertisement.

18. The system of claim 17, wherein the second playback device is further configured to determine whether an identifier of the first playback device is stored in a list of devices previously paired with the second playback device.

19. The system of claim 18, wherein the second playback device is configured to start a BLE broadcast session after tear down of the first connection and prior to establishment of the second connection.

20. The system of claim 19, wherein:
the second playback device is configured to communicate a copy of audio data to the first playback device via the second connection; and
the first playback device is configured to play back audio content based on the copy of the audio data.

21. The system of claim 12, wherein to establish the first connection with the second playback device comprises to determine that a first distance between the first playback device and the second playback device is less than a second distance between the first playback device and a third playback device.

22. The system of claim 12, wherein:
the first playback device comprises headphones;
the second playback device comprises a sound bar;
the user interface comprises a button; and
to receive the input comprises to receive an indication of actuation of the button.

23. The system of claim 12, wherein the first playback device is configured to exchange volume control information with the second playback device.

24. A method for operating a first playback device, the method comprising:
detecting input, via a user interface of the first playback device, the input specifying a request to establish a network connection between the first playback device and a second playback device;
detecting, via a PAN interface of the first playback device, a message from the second playback device, the message specifying an identifier of the second playback device;
identifying connection attributes associated with the second playback device;
establishing, via one of a plurality of network interfaces of the first playback device, a connection with the second playback device based on the connection attributes; and
playing back audio content received via the connection to the second playback device.

25. The method of claim 24, wherein:
the connection attributes specify a connection type supported by the second playback device; and
establishing the connection comprises extracting the connection type from the connection attributes.

26. The method of claim 25, wherein the connection type is either a PAN connection type or a local area network (LAN) connection type.

27. The method of claim 26, wherein:
the plurality of network interfaces of the first playback device comprises the PAN interface and a LAN interface;
the PAN interface is configured to facilitate communication using at least one BLUETOOTH communication protocol;
the LAN interface is configured to facilitate communication using at least one WI-FI communication protocol; and
the connection type is either a BLUETOOTH connection type or a WI-FI connection type.

28. The method of claim 27, wherein the PAN interface comprises a BLUETOOTH low energy (BLE) interface.

29. The method of claim 28, wherein the message comprises a BLE advertisement.

30. The method of claim 29, wherein establishing the connection with the second playback device comprises determining that a first distance between the first playback device and the second playback device is less than a second distance between the first playback device and a third playback device.

31. The method of claim 30, further comprising estimating the first distance based on a comparison of a power of a signal conveying the BLE advertisement to a transmission power stored in the BLE advertisement.

32. The method of claim 24, further comprising:
terminating the connection with the second playback device;
accepting a new connection with the second playback device, the new connection established by the second playback device; and
playing back audio content received via the new connection to the second playback device.

33. The method of claim 24, further comprising, after establishing the connection with the second playback device, exchanging volume control information between the first playback device and the second playback device.
